(19) United States
(12) Patent Application Publication
(10) Pub. No.: US 2026/0205984 A1
(43) Pub. Date: Jul. 16, 2026

(54) CARRIER PHASE POSITIONING REPORTING

(71) Applicant: LENOVO (SINGAPORE) PTE. LTD., Singapore (SG)

(72) Inventors: Robin Rajan Thomas, Bad Nauheim (DE); Abir Ben Hadj Fredj, Wiesbaden (DE); Colin Frank, Park Ridge, IL (US)

(73) Assignee: LENOVO (SINGAPORE) PTE. LTD., Singapore (SG)

(21) Appl. No.: 19/132,603

(22) PCT Filed: Jan. 12, 2024
(86) PCT No.: PCT/IB2024/050350

§ 371 Date: May 23, 2025

Related U.S. Application Data
(60) Provisional application No. 63/480,189, filed on Jan. 17, 2023.

(51) Int. Cl. H04W 64/00; H04W 24/10

(52) U.S. Cl. CPC H04W 64/00; H04W 24/10

(57) ABSTRACT

Various aspects of the present disclosure relate to carrier phase positioning reporting. A network entity provides a carrier phase positioning reporting configuration to a user equipment. The user equipment generates one or more carrier phase measurement reports based on the received carrier phase positioning reporting configuration. The user equipment transmits the generated carrier phase measurement report to a network entity, which may be the same network entity that the carrier phase positioning reporting configuration was received from or a different network entity.

### RELATED APPLICATION

This application claims priority to U.S. patent application Ser. No. 63/480,189 filed Jan. 17, 2023 entitled “Carrier Phase Positioning Reporting,” the disclosure of which is incorporated by reference herein in its entirety.

### TECHNICAL FIELD

The present disclosure relates to wireless communications, and more specifically to carrier phase positioning reporting.

### BACKGROUND

A wireless communications system may include one or multiple network communication devices, such as base stations, which may be otherwise known as an eNodeB (eNB), a next-generation NodeB (gNB), or other suitable terminology. Each network communication devices, such as a base station may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

The wireless communications system enables UE-assisted and UE-based positioning methods in the third generation partnership project (3GPP) positioning framework. However, direct UE-to-UE range/distance and orientation determinations are not currently supported, which would facilitate relative positioning applications across other services, such as for vehicle-to-everything (V2X), public safety, industrial Internet of things (IIoT), commercial, and other applications.

### SUMMARY

The present disclosure relates to methods, apparatuses, and systems that support carrier phase positioning reporting. A network entity provides a carrier phase positioning reporting configuration to a UE. The UE generates one or more carrier phase measurement reports based on the received carrier phase positioning reporting configuration. The UE transmits the generated carrier phase measurement report to a network entity, which may be the same network entity that the carrier phase positioning reporting configuration was received from or a different network entity or configuration entity, e.g., another UE. By transmitting carrier phase measurement reports based on the carrier phase positioning reporting configuration, carrier phase measurements can be communicated between devices and nodes within a network through a reporting configuration that allows accurate and timely reporting of the carrier phase measurements.

Some implementations of the method and apparatuses described herein may further include to: receive, from a configuration entity, a first signaling indicating a carrier phase positioning reporting configuration, wherein the carrier phase positioning reporting configuration includes at least one of a set of receiver error types or a carrier phase granularity; generate multiple carrier phase measurement reports that include multiple carrier phase positioning measurements based on the received reporting configuration; transmit, to a configuration entity, multiple second signalings indicating the multiple carrier phase measurement reports.

In some implementations of the method and apparatuses described herein, the carrier phase reporting configuration further includes a request to provide additional radio access technology (RAT)-dependent positioning measurements including at least one of a downlink reference signal time difference (DL-RSTD), a user equipment receive-transmit (UE Rx-Tx) time difference, a downlink positioning reference signals reference signal received power (DL PRS RSRP), a downlink positioning reference signals reference signal received path power (DL PRS RSRPP), a sidelink reference signal time difference (SL-RSTD), a sidelink relative time of arrival (SL-RTOA), a sidelink positioning reference signals reference signal received power (SL PRS RSRP), a sidelink positioning reference signals reference signal received path power (SL PRS RSRPP), or a sidelink angle-of-arrival (SL-AoA). Additionally or alternatively, the carrier phase positioning reporting configuration includes a set of receiver error types including at least one of an initial phase offset, an initial phase offset group, a user equipment (UE) antenna reference point location error, an oscillator drift or clock offset, a carrier frequency offset, and an antenna phase center offset. Additionally or alternatively, each of the error types is associated with an identifier. Additionally or alternatively, the carrier phase positioning measurements are reported in the carrier phase measurement reports per transmission-reception point (TRP) in a form of a plurality of single carrier phase measurements or per pair of TRPs in a form of a plurality of reference signal carrier phase difference measurements. Additionally or alternatively, the carrier phase positioning measurements are reported in the carrier phase measurement reports based on a defined granularity or step values in terms of radians or degrees. Additionally or alternatively, the carrier phase positioning measurements are reported in the carrier phase measurement reports based on a defined quality metric. Additionally or alternatively, a delta or difference carrier phase measurement is reported in the carrier phase measurement reports with respect to a previously performed carrier phase positioning measurement and a current carrier phase measurement. Additionally or alternatively, the method and apparatus further include to transmit, to the configuration entity, an apparatus error cause related to carrier phase positioning. Additionally or alternatively, the method and apparatus further include to receive a configuration entity error cause related to carrier phase positioning. Additionally or alternatively, the method and apparatus further include to cause the apparatus to support, via capability request and response messages, awareness of devices capable of supporting carrier phase measurements. Additionally or alternatively, the apparatus comprises a UE. Additionally or alternatively, the method and apparatus further include to transmit a request for positioning reference unit (PRU) carrier phase measurements and/or associated information, and receive a response of PRU carrier phase measurements and/or associated information in a case of UE-based positioning. Additionally or alternatively, the associated information includes at least one of PRU integer ambiguity information and quality metrics positioning reference signals (PRS) resource identifiers (IDs), PRS resource set IDs, TRP IDs, PRU identifying information, PRU IDs, LOS/NLOS information related to each of the carrier phase positioning measurements, additional path information related to each of the carrier phase positioning measurements, PRU receiver error type information including any oscillator drift, clock drift, initial PRU phase offsets or group of phase offsets, PRU antenna reference point (ARP) location error, PRU phase center offset, PRU measurement time stamp information, or carrier phase or timing measurement quality metrics.

Some implementations of the method and apparatuses described herein may further include to: receive, from a UE, a first signaling indicating a carrier phase measurement report in accordance with a carrier phase positioning reporting configuration, wherein the carrier phase positioning reporting configuration includes at least one of a set of receiver error types or a carrier phase granularity, and wherein the carrier phase measurement report includes at least one carrier phase positioning measurement; obtain, based on the carrier phase measurement report, a location information of the UE.

In some implementations of the method and apparatuses described herein, the apparatus comprises a network entity and the method and apparatus further include to transmit, to the UE, the carrier phase reporting configuration. Additionally or alternatively, the apparatus comprises a network entity and the method and apparatus further include to transmit, to the UE, a carrier phase measurement request to report uplink carrier phase measurements, the carrier phase measurement request including the carrier phase reporting configuration. Additionally or alternatively, the carrier phase reporting configuration further includes a request to provide additional RAT-dependent positioning measurements including at least one of a DL-RSTD, a UE Rx-Tx time difference, a DL PRS RSRP, a DL PRS RSRPP, a SL-RSTD, a SL-RTOA, a SL PRS RSRP, a SL PRS RSRPP, and a SL-AoA. Additionally or alternatively, the carrier phase reporting configuration further includes a request to report location information based on the performed carrier phase measurements. Additionally or alternatively, the carrier phase positioning reporting configuration includes a set of receiver error types includes at least one of an initial phase offset, an initial phase offset group, a UE antenna reference point location error, an oscillator drift or clock offset, a carrier frequency offset, and an antenna phase center offset. Additionally or alternatively, each of the error types is associated with an identifier. Additionally or alternatively, the at least one carrier phase positioning measurement is reported in the carrier phase measurement report per TRP in a form of a plurality of single carrier phase measurements or per pair of TRPs in a form of a plurality of reference signal carrier phase difference measurements. Additionally or alternatively, the at least one carrier phase positioning measurement is reported in the carrier phase measurement report based on a defined granularity or step values in terms of radians or degrees. Additionally or alternatively, the at least one carrier phase positioning measurement is reported in the carrier phase measurement report based on a defined quality metric. Additionally or alternatively, a delta or difference carrier phase measurement is reported in the carrier phase measurement report with respect to a previously performed carrier phase positioning measurement and a current carrier phase measurement. Additionally or alternatively, the method and apparatus further include to receive, from the UE, a UE error cause related to carrier phase positioning. Additionally or alternatively, the method and apparatus further include to cause the apparatus to transmit, to the UE, a configuration entity error cause related to carrier phase positioning. Additionally or alternatively, the method and apparatus further include to support, via capability request and response messages, awareness of devices capable of supporting carrier phase measurements. Additionally or alternatively, the method and apparatus further include to cause the apparatus to cause the apparatus to receive a request for PRU carrier phase measurements and/or associated information, and transmit, to the UE, a response of PRU carrier phase measurements and/or associated information in a case of UE-based positioning. Additionally or alternatively, the associated information includes at least one of PRU integer ambiguity information and quality metrics PRS resource IDs, PRS resource set IDs, TRP IDs, PRU identifying information, PRU IDs, LOS/NLOS information related to each of the carrier phase positioning measurements, additional path information related to each of the carrier phase positioning measurements, PRU receiver error type information including any oscillator drift, clock drift, initial PRU phase offsets or group of phase offsets, PRU ARP location error, PRU phase center offset, PRU measurement time stamp information, or carrier phase or timing measurement quality metrics.

### BRIEF DESCRIPTION OF THE DRAWINGS

FIG. 1 illustrates an example of a wireless communications system that supports carrier phase positioning reporting in accordance with aspects of the present disclosure.

FIG. 2 illustrates an example of a system of NR beam-based positioning as related to carrier phase positioning reporting in accordance with aspects of the present disclosure.

FIG. 3 illustrates an example of absolute and relative positioning scenarios as related to carrier phase positioning reporting in accordance with aspects of the present disclosure.

FIG. 4 illustrates an example of a multi-cell round trip time (RTT) procedure as related to carrier phase positioning reporting in accordance with aspects of the present disclosure.

FIG. 5 illustrates an example of a system for existing relative range estimation as related to carrier phase positioning reporting in accordance with aspects of the present disclosure.

FIG. 6 illustrates an example of downlink (DL) or sidelink (SL) carrier phase measurement request and response report messaging as related to carrier phase positioning reporting in accordance with aspects of the present disclosure.

FIGS. 7A and 7B illustrates an example request information element (IE) message as related to carrier phase positioning reporting in accordance with aspects of the present disclosure.

FIGS. 8A and 8B illustrate an example response IE message as related to carrier phase positioning reporting in accordance with aspects of the present disclosure.

FIG. 9 illustrates an example of uplink (UL) carrier phase measurement request and response report messaging as related to carrier phase positioning reporting in accordance with aspects of the present disclosure.

FIG. 10 illustrates an example of DL or SL Carrier phase capability exchange messages as related to carrier phase positioning reporting in accordance with aspects of the present disclosure.

FIG. 11 illustrates an example IE message as related to carrier phase positioning reporting in accordance with aspects of the present disclosure.

FIG. 12 illustrates an example IE message as related to carrier phase positioning reporting in accordance with aspects of the present disclosure.

FIGS. 13 and 14 illustrate an example of a block diagram of a device that supports carrier phase positioning reporting in accordance with aspects of the present disclosure.

FIGS. 15 through 21 illustrate flowcharts of methods that support carrier phase positioning reporting in accordance with aspects of the present disclosure.

### DETAILED DESCRIPTION

SL positioning may potentially support a variety of RAT-dependent positioning techniques including but not limited to SL-TDoA, SL-RTT, SL-AoA, and so forth. One positioning technique, carrier phase positioning (CPP), uses carrier phase measurements to determine the distance between two nodes or entities as well as the absolute location of a target-UE. In addition, the use of carrier phase measurements does not require large bandwidths as compared to other positioning techniques that require fine time or angular resolution for improved location performance. Carrier phase positioning can therefore be leveraged in bandwidth limited scenarios.

Although there exists a 3GPP positioning framework, which enables Uu interface UE-assisted and UE-based positioning methods, there is currently a lack of support for direct UE-to-UE absolute/relative location, distance or orientation determination, which is essential to support relative positioning applications across different vertical services, e.g., V2X, Public Safety, IIoT, Commercial, and so forth.

The techniques discussed herein support carrier phase measurements between devices and nodes within a network through a reporting configuration to enable the accurate and timely reporting of the carrier phase measurements or location information derived based on at least carrier phase measurements. A network entity provides a carrier phase positioning reporting configuration to a UE. The UE generates one or more carrier phase measurement reports based on the received carrier phase positioning reporting configuration. The UE transmits the generated carrier phase measurement report to a network entity, which may be the same network entity that the carrier phase positioning reporting configuration was received from or a different network entity.

Carrier phase measurements between devices and nodes within a network is supported using various different techniques. In one or more implementations, the techniques discussed herein allow for different types of DL and SL carrier phase measurement reporting according to the requested reporting configuration. Additionally or alternatively, the techniques discussed herein allow for different types of UL carrier phase measurement reporting according to the requested reporting configuration. Additionally or alternatively, the techniques discussed herein allow for awareness of devices capable of supporting carrier phase measurements over the Uu or PC5. Additionally or alternatively, the techniques discussed herein allow for error report notification relating to misconfigured DL or SL carrier phase configurations and/or inaccurate or faulty measurements.

The techniques discussed herein allow carrier phase positioning techniques to be used and carrier phase measurements to be communicated between devices and nodes within a network through a reporting configuration that allows accurate and timely reporting of the carrier phase measurements. The techniques discussed herein further allow for flexibility in using carrier positioning techniques with a configuration entity being able to specify various aspects of carrier phase measurements and measurement reporting via a carrier phase positioning reporting configuration. The techniques discussed herein further allow for identifying other devices capable of supporting carrier phase measurements.

Aspects of the present disclosure are described in the context of a wireless communications system. Aspects of the present disclosure are further illustrated and described with reference to device diagrams and flowcharts.

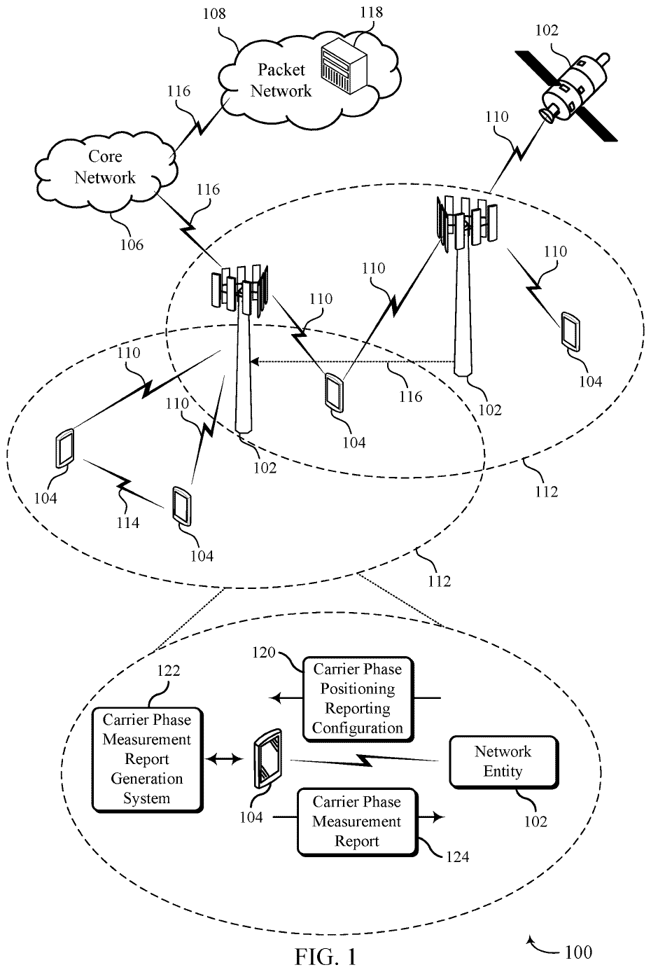

FIG. 1 illustrates an example of a wireless communications system 100 that supports carrier phase positioning reporting in accordance with aspects of the present disclosure. The wireless communications system 100 may include one or more network entities 102, one or more UEs 104, a core network 106, and a packet data network 108. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a radio access network (RAN), a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, N6, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., Radio Resource Control (RRC), service data adaption protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), a user plane function (UPF)), or a location management function (LMF), which is a control plane entity that manages location services. In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, N6, or another network interface). The packet data network 108 may include an application server 118. In some implementations, one or more UEs 104 may communicate with the application server 118. A UE 104 may establish a session (e.g., a protocol data unit (PDU) session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communication system 100 (e.g., time resources (e.g., symbols, slots, subframes, frames, or the like) or frequency resources (e.g., subcarriers, carriers) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (i.e., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. The first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. Each slot may include a number (e.g., quantity) of symbols (e.g., orthogonal frequency division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHz), FR3 (7.125 GHZ-24.25 GHz), FR4 (52.6 GHz-114.25 GHZ), FR4a or FR4-1 (52.6 GHZ-71 GHz), and FR5 (114.25 GHZ-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

A network entity 102 provides a carrier phase positioning reporting configuration 120 to a UE 104. The network entity 102 may be, for example, a SL positioning server UE, an anchor UE or positioning reference unit (PRU), or a location server (LMF). The UE 104 includes a carrier phase measurement report generation system 122 that generates a carrier phase measurement report 124 based on the received carrier phase positioning reporting configuration 120. The UE 104 transmits the carrier phase measurement report 124 to the network entity 102. Although the UE 104 is illustrated as transmits the carrier phase measurement report 124 to the network entity 102 from which the carrier phase positioning reporting configuration 120 was received, additionally or alternatively the UE 104 transmits the carrier phase measurement report 124 to another network entity rather than to the network entity 102 from which the carrier phase positioning reporting configuration 120 was received.

Communication between devices discussed herein, such as between UEs 104 and network entities 102, is performed using any of a variety of different signaling. For example, such signaling can be any of various messages, requests, or responses, such as triggering messages, configuration messages, and so forth. By way of another example, such signaling can be any of various signaling mediums or protocols over which messages are conveyed, such as any combination of radio resource control (RRC), downlink control information (DCI), uplink control information (UCI), sidelink control information (SCI), medium access control element (MAC-CE), sidelink positioning protocol (SLPP), PC5 radio resource control (PC5-RRC) and so forth.

NR positioning based on NR Uu signals and SA architecture (e.g., beam-based transmissions) was first specified in Release 16. The targeted use cases also included commercial and regulatory (emergency services) scenarios as in Release 15. The performance requirements are the following:

| Positioning Error | Indoor | Outdoor |
|---|---|---|
| Horizontal | <3 m for 80% of UEs | <10 m for 80% of UEs |
| Positioning | | |
| Vertical Positioning | <3 m for 80% of UEs | <3 m for 80% of UEs |

Current 3GPP Release 17 Positioning has defined the positioning performance requirements for Commercial and IIoT use cases as follows:

| Positioning Error | Commercial | IIoT |
|---|---|---|
| Horizontal Positioning | (<1 m) for | (<0.2 m) for |
| | 90% of UEs | 90% of UEs; |
| Vertical Positioning | (<3 m) for | (<1 m) for |
| | 90% of UEs | 90% of UEs |
| Physical layer latency | (<10 ms) | (<10 ms) |
| for position estimation | | |
| of UE | | |
| End-to-End Latency | (<100 ms) | (<100 ms, in |
| for position estimation | | the order of 10 |
| of UE | | ms is desired) |

The supported positioning techniques in Release 16 are listed in Table 1.

TABLE 1
Supported Rel-16 UE positioning methods

| | | UE- | NG-RAN | |
|---|---|---|---|---|
| | UE- | assisted, | node | |
| Method | based | LMF-based | assisted | SUPL |
| A-GNSS | Yes | Yes | No | Yes (UE-based |
| | | | | and UE-assisted) |
| OTDOA ^{Note1, Note 2} | No | Yes | No | Yes (UE-assisted) |
| E-CID ^{Note 4} | No | Yes | Yes | Yes for E-UTRA |
| | | | | (UE-assisted) |
| Sensor | Yes | Yes | No | No |
| WLAN | Yes | Yes | No | Yes |
| Bluetooth | No | Yes | No | No |
| TBS ^{Note 5} | Yes | Yes | No | Yes (MBS) |
| DL-TDOA | Yes | Yes | No | No |
| DL-AoD | Yes | Yes | No | No |
| Multi-RTT | No | Yes | Yes | No |
| NR E-CID | No | Yes | FFS | No |
| UL-TDOA | No | No | Yes | No |
| UL-AoA | No | No | Yes | No |

^{Note 1} This includes terrestrial beacon system (TBS) positioning based on PRS signals.
^{Note 2} In this version of the specification only observed time difference of arrival (OTDOA) based on LTE signals is supported.
^{Note 4} This includes Cell-ID for NR method.
^{Note 5} In this version of the specification only for TBS positioning based on MBS signals.

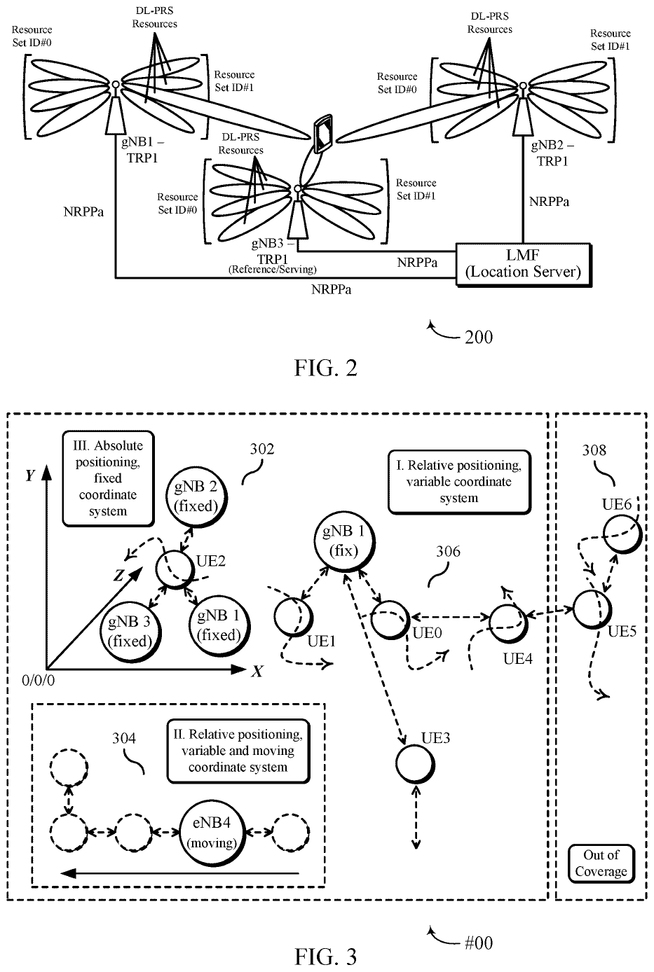

Separate positioning techniques as indicated in Table 1 can be currently configured and performed based on the requirements of the LMF and UE capabilities. The transmission of Uu (uplink and downlink) positioning reference signals (PRS) enable the UE to perform UE positioning-related measurements to enable the computation of a UE's absolute location estimate and are configured per transmission reception point (TRP), where a TRP may include a set of one or more beams. A conceptual overview is illustrated in FIG. 2.

FIG. 2 illustrates an example of a system 200 of NR beam-based positioning as related to carrier phase positioning reporting in accordance with aspects of the present disclosure. The system 200 illustrates a UE 104 and network entities 102 (e.g., gNBs). The PRS can be transmitted by different base stations (serving and neighboring) using narrow beams over FR1 and FR2 as illustrated in the example system 200, which is relatively different when compared to LTE where the PRS was transmitted across the whole cell. The PRS can be locally associated with a PRS Resource identifier (ID) and Resource Set ID for a base station (TRP). Similarly, UE positioning measurements such as reference signal time difference (RSTD) and PRS reference signal received power (RSRP) measurements are made between beams (e.g., between a different pair of downlink (DL) PRS resources or DL PRS resource sets) as opposed to different cells as was the case in LTE. In addition, there are additional uplink (UL) positioning methods for the network to exploit in order to compute the target UE's location.

Tables 2 and 3 show the reference signal to measurements mapping for each of the supported RAT-dependent positioning techniques at the UE and gNB, respectively. The RAT-dependent positioning techniques may utilize the 3GPP RAT and core network entities to perform the position estimation of the UE, which are differentiated from RAT-independent positioning techniques, which rely on global navigation satellite system (GNSS), inertial measurement unit (IMU) sensor, WLAN, and Bluetooth technologies for performing target device (UE) positioning.

TABLE 2
UE Measurements to enable RAT-dependent
positioning techniques

| | | To facilitate support |
|---|---|---|
| DL/UL Reference | | of the following |
| Signals | UE Measurements | positioning techniques |
| Rel. 16 DL PRS | DL RSTD | DL-TDOA |
| Rel. 16 DL PRS | DL PRS RSRP | DL-TDOA, DL-AoD, |
| | | Multi-RTT |
| Rel. 16 DL PRS/ | UE Rx − Tx time | Multi-RTT |
| Rel. 16 SRS for | difference | |
| positioning | | |
| Rel. 15 SSB/CSI-RS | SS-RSRP(RSRP for | E-CID |
| for RRM | RRM), SS-RSRQ(for | |
| | RRM), CSI-RSRP (for | |
| | RRM), CSI-RSRQ (for | |
| | RRM), SS-RSRPB | |
| | (for RRM) | |

TABLE 3
gNB Measurements to enable RAT-
dependent positioning techniques

| | | To facilitate support |
|---|---|---|
| DL/UL Reference | | of the following |
| Signals | gNB Measurements | positioning techniques |
| Rel. 16 SRS for | UL RTOA | UL-TDOA |
| positioning | | |
| Rel. 16 SRS for | UL SRS-RSRP | UL-TDOA, UL-AoA, |
| positioning | | Multi-RTT |
| Rel. 16 SRS for | gNB Rx − Tx time | Multi-RTT |
| positioning, Rel. | difference | |
| 16 DL PRS | | |
| Rel. 16 SRS for | AoA and ZoA | UL-AoA, Multi-RTT |
| positioning, | | |

FIG. 3 illustrates an example 300 of absolute and relative positioning scenarios as related to carrier phase positioning reporting in accordance with aspects of the present disclosure. The network devices described with reference to example 300 may use and/or be implemented with the wireless communications system 100 and include UEs 104 and network entities 102 (e.g., eNB, gNB). The example 300 is an overview of absolute and relative positioning scenarios as defined in the architectural (stage 1) specifications using three different co-ordinate systems, including (III) a conventional absolute positioning, fixed coordinate system at 302; (II) a relative positioning, variable and moving coordinate system at 304; and (I) a relative positioning, variable coordinate system at 306. Notably, the relative positioning, variable coordinate system at 306 is based on relative device positions in a variable coordinate system, where the reference may be always changing with the multiple nodes that are moving in different directions. The example 300 also includes a scenario 308 for an out of coverage area in which UEs need to determine relative position with respect to each other.

The relative positioning, variable and moving coordinate system at 304 may support relative lateral position accuracy of 0.1 meters between UEs supporting V2X applications, and may support relative longitudinal position accuracy of less than 0.5 meters for UEs supporting V2X applications for platooning in proximity. The relative positioning, variable coordinate system at 306 may support relative positioning between one UE and positioning nodes within 10 meters of each other. The relative positioning, variable coordinate system at 306 may also support vertical location of a UE in terms of relative height/depth to local ground level.

Various RAT-dependent positioning techniques are supported in Release 16 and Release 17, such as DL-TDoA, DL-AoD, Multi-RTT, E-CID/NR E-CID, UL-TDoA, and UL-AoA.

The DL-TDOA positioning method makes use of the DL RSTD (and optionally DL PRS RSRP) of downlink signals received from multiple TPs, at the UE. The UE measures the DL RSTD (and optionally DL PRS RSRP) of the received signals using assistance data received from the positioning server, and the resulting measurements are used along with other configuration information to locate the UE in relation to the neighboring TPs.

The DL AoD positioning method makes use of the measured DL PRS RSRP of downlink signals received from multiple TPs, at the UE. The UE measures the DL PRS RSRP of the received signals using assistance data received from the positioning server, and the resulting measurements are used along with other configuration information to locate the UE in relation to the neighboring TPs.

The Multi-RTT positioning method makes use of the UE Rx-Tx measurements and DL PRS RSRP of downlink signals received from multiple TRPs, measured by the UE and the measured gNB Rx-Tx measurements and UL SRS-RSRP at multiple TRPs of uplink signals transmitted from UE.

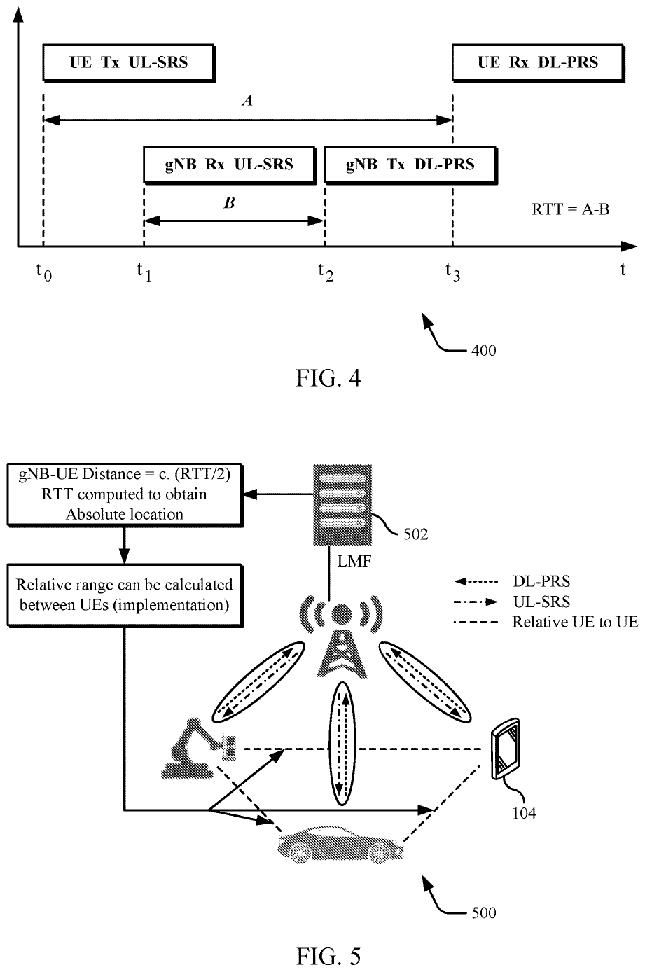

FIG. 4 illustrates an example 400 of a multi-cell RTT procedure as related to carrier phase positioning reporting in accordance with aspects of the present disclosure. The multi-RTT positioning technique makes use of the UE Rx-Tx measurements and DL PRS RSRP of downlink signals received from multiple TRPs, as measured by the UE and the measured gNB Rx-Tx measurements and uplink sounding reference signal (SRS) RSRP (UL SRS-RSRP) at multiple TRPs of uplink signals transmitted from UE. The UE measures the UE Rx-Tx measurements (and optionally DL PRS RSRP of the received signals) using assistance data received from the positioning server (also referred to herein as the location server), and the TRPs the gNB Rx-Tx measurements (and optionally UL SRS-RSRP of the received signals) using assistance data received from the positioning server. The measurements are used to determine the RTT at the positioning server, which are used to estimate the location of the UE. In Release 16 the multi-RTT is only supported for UE-assisted and NG-RAN assisted positioning techniques as noted in Table 1.

FIG. 5 illustrates an example of a system 500 for existing relative range estimation as related to carrier phase positioning reporting in accordance with aspects of the present disclosure. The system 500 illustrates the relative range estimation using the existing single gNB RTT positioning framework. The location server (LMF) can configure measurements to the different UEs, and then the target UEs can report their measurements in a transparent way to the location server. The location server can compute the absolute location, but in order to get the relative distance between two of the UEs, it would need prior information, such as the locations of the target UEs. This approach is high in latency and is not an efficient method in terms of procedures and signaling overhead.

For the NR enhanced cell ID (E-CID) positioning technique, the position of a UE is estimated with the knowledge of its serving ng-eNB, gNB, and cell, and is based on LTE signals. The information about the serving ng-eNB, gNB, and cell may be obtained by paging, registration, or other methods. The NR enhanced cell-ID (NR E-CID) positioning refers to techniques which use additional UE measurements and/or NR radio resources and other measurements to improve the UE location estimate using NR signals. Although enhanced cell-ID (E-CID) positioning may utilize some of the same measurements as the measurement control system in the RRC protocol, the UE may not make additional measurements for the sole purpose of positioning (e.g., the positioning procedures do not supply a measurement configuration or measurement control message, and the UE reports the measurements that it has available rather than being required to take additional measurement actions).

The uplink time difference of arrival (UL-TDOA) positioning technique makes use of the UL-RTOA (and optionally UL SRS-RSRP) at multiple reception points (RPs) of uplink signals transmitted from UE. The RPs measure the UL-RTOA (and optionally UL SRS-RSRP) of the received signals using assistance data received from the positioning server, and the resulting measurements are used along with other configuration information to estimate the location of the UE.

The uplink angle of arrival (UL-AoA) positioning technique makes use of the measured azimuth and the zenith of arrival at multiple RPs of uplink signals transmitted from UE. The RPs measure azimuth-AoA (A-AoA) and zenith-AoA (Z-AoA) of the received signals using assistance data received from the positioning server (also referred to herein as the location server), and the resulting measurements are used along with other configuration information to estimate the location of the UE.

Various RAT-independent positioning techniques may also be used, such as network-assisted GNSS techniques, barometric pressure sensor positioning, WLAN positioning, Bluetooth positioning, TBS positioning, and motion sensor positioning.

Network-assisted GNSS techniques make use of UEs that are equipped with radio receivers capable of receiving GNSS signals. In 3GPP specifications the term GNSS encompasses both global and regional/augmentation navigation satellite systems. Examples of global navigation satellite systems include global positioning system (GPS), Modernized GPS, Galileo, GLONASS, and BeiDou Navigation Satellite System (BDS). Regional navigation satellite systems include Quasi Zenith Satellite System (QZSS) while the many augmentation systems are classified under the generic term of Space Based Augmentation Systems (SBAS) and provide regional augmentation services. Network-assisted GNSS techniques may use different GNSSs (e.g., GPS, Galileo, etc.) separately or in combination to determine the location of a UE.

Barometric pressure sensor positioning techniques make use of barometric sensors to determine the vertical component of the position of the UE. The UE measures barometric pressure, optionally aided by assistance data, to calculate the vertical component of its location or to send measurements to the positioning server for position calculation. This technique should be combined with other positioning methods to determine the 3D position of the UE.

WLAN positioning techniques makes use of the WLAN measurements (access point (AP) identifiers and optionally other measurements) and databases to determine the location of the UE. The UE measures received signals from WLAN access points, optionally aided by assistance data, to send measurements to the positioning server for position calculation. Using the measurement results and a references database, the location of the UE is calculated. Additionally or alternatively, the UE makes use of WLAN measurements and optionally WLAN AP assistance data provided by the positioning server to determine its location.

Bluetooth positioning techniques makes use of Bluetooth measurements (beacon identifiers and optionally other measurements) to determine the location of the UE. The UE measures received signals from Bluetooth beacons. Using the measurement results and a references database, the location of the UE is calculated. The Bluetooth methods may be combined with other positioning methods (e.g., WLAN) to improve positioning accuracy of the UE.

TBS positioning techniques make use of a TBS, which includes a network of ground-based transmitters, broadcasting signals only for positioning purposes. Examples of types of TBS positioning signals are MBS (Metropolitan Beacon System) signals and Positioning Reference Signals (PRS). The UE measures received TBS signals, optionally aided by assistance data, to calculate its location or to send measurements to the positioning server for position calculation.

Motion sensor positioning techniques makes use of different sensors such as accelerometers, gyros, magnetometers, and so forth to calculate the displacement of UE. The UE estimates a relative displacement based upon a reference position and/or reference time. The UE sends a report comprising the determined relative displacement which can be used to determine the absolute position. This method can be used with other positioning methods for hybrid positioning.

Different DL measurements used for RAT-dependent positioning techniques include including DL PRS-RSRP, DL RSTD and UE Rx-Tx Time Difference. The following measurement configurations may be used: 4 Pair of DL RSTD measurements can be performed per pair of cells, and each measurement is performed between a different pair of DL PRS Resources/Resource Sets with a single reference timing; 8 DL PRS RSRP measurements can be performed on different DL PRS resources from the same cell.

DL PRS reference signal received power (DL PRS-RSRP) is defined as the linear average over the power contributions (in [W]) of the resource elements that carry DL PRS reference signals configured for RSRP measurements within the considered measurement frequency bandwidth. For frequency range 1, the reference point for the DL PRS-RSRP is the antenna connector of the UE. For frequency range 2, DL PRS-RSRP is measured based on the combined signal from antenna elements corresponding to a given receiver branch. For frequency range 1 and 2, if receiver diversity is in use by the UE, the reported DL PRS-RSRP value is not lower than the corresponding DL PRS-RSRP of any of the individual receiver branches. DL PRS-RSRP is applicable for RRC_CONNECTED intra-frequency and RRC_CONNECTED inter-frequency.

DL reference signal time difference (DL RSTD) is the DL relative timing difference between the positioning node j and the reference positioning node i, defined as T_{SubframeRxj}−T_{SubframeRxi}, where T_{SubframeRxj} is the time when the UE receives the start of one subframe from positioning node j, and T_{SubframeRxi} is the time when the UE receives the corresponding start of one subframe from positioning node i that is closest in time to the subframe received from positioning node j. Multiple DL PRS resources can be used to determine the start of one subframe from a positioning node. For frequency range 1, the reference point for the DL RSTD is the antenna connector of the UE. For frequency range 2, the reference point for the DL RSTD is the antenna of the UE. DL RSTD is applicable for RRC_CONNECTED intra-frequency and RRC_CONNECTED inter-frequency.

The UE Rx-Tx time difference is defined as T_{UE-RX}-T_{UE-TX}, where T_{UE-RX} is the UE received timing of downlink subframe #i from a positioning node, defined by the first detected path in time, and T_{UE-TX} is the UE transmit timing of uplink subframe #j that is closest in time to the subframe #i received from the positioning node. Multiple DL PRS resources can be used to determine the start of one subframe of the first arrival path of the positioning node. For frequency range 1, the reference point for T_{UE-RX} measurement shall be the receive (Rx) antenna connector of the UE and the reference point for T_{UE-TX} measurement shall be the transmit (Tx) antenna connector of the UE. For frequency range 2, the reference point for T_{UE-RX} measurement shall be the Rx antenna of the UE and the reference point for T_{UE-TX} measurement shall be the Tx antenna of the UE. The UE Rx-Tx time difference is applicable for RRC_CONNECTED intra-frequency and RRC_CONNECTED inter-frequency.

The DL PRS reference signal received path power (DL PRS-RSRPP) is defined as the power of the linear average of the channel response at the i-th path delay of the resource elements that carry DL PRS signal configured for the measurement, where DL PRS-RSRPP for the 1st path delay is the power contribution corresponding to the first detected path in time. For frequency range 1, the reference point for the DL PRS-RSRPP is the antenna connector of the UE. For frequency range 2, DL PRS-RSRPP is measured based on the combined signal from antenna elements corresponding to a given receiver branch. DL PRS-RSRPP is applicable for RRC_CONNECTED and RRC_INACTIVE.

In one or more implementations, NR carrier phase positioning performance being evaluated at least with the carrier phase measurements of a single measurement instance is considered.

In one or more implementations, the impact of integer ambiguity on NR carrier phase positioning and potential solutions to resolve the integer ambiguity is considered.

In one or more implementations, the study of the accuracy improvement based on NR carrier phase measurements may consider: UE-based and UE-assisted carrier phase positioning; UL carrier phase positioning and DL carrier phase positioning; NR carrier phase positioning with the carrier phase measurements of one carrier frequency or multiple frequencies; a combination of NR carrier phase positioning with another standardized Rel. 17 positioning method, e.g., DL-TDOA, UL-TDOA, Multi-RTT, etc. It should be noted that the use of “carrier phase positioning” does not necessarily mean it is a standalone positioning method.

In one or more implementations, the impact of multipath for the carrier phase positioning is considered.

In one or more implementations, methods of mitigating the impact of multipath for the carrier phase positioning is considered.

In one or more implementations, reuse of the simulation assumptions of NR Rel-16/17 for carrier phase positioning is considered. Additionally or alternatively, optional modification of the simulation assumptions defined in NR Rel-16/17 if needed is considered.

In one or more implementations, baseline and optional evaluation scenarios are considered. For example, the baseline evaluation scenario may include at least one of InF-SH and InF-DH. By way of another example, the optional evaluation scenario may include at least one of IOO, Umi, and Highway. It should be noted that other evaluation scenarios are not precluded, and that existing Rel-17 DL/UL reference signals in Uu interface can be used for the Highway scenario. For the baseline evaluation scenario the frequency range may be FR1, and for the optional evaluation scenario the frequency range may be FR2.

In one or more implementations (e.g., in addition to the evaluation assumptions of NR Rel-16/17), at least one of the following error sources may also be considered: phase noise (e.g., in FR2), carrier frequency offset (CFO)/Doppler, oscillator-drift, transmitter/receiver antenna reference point location errors, transmitter/receiver initial phase error, and phase center offset. It should be noted that other error sources are not precluded. Additionally or alternatively, UE mobility can be considered. Additionally or alternatively, one or more error sources can be evaluated jointly. Additionally or alternatively, error sources models are provided with their evaluations.

In one or more implementations, the following is considered. For NR downlink and/or uplink carrier phase positioning, the carrier phase (CP) at a radio frequency (RF) frequency at a receiver is a phase that is a function of the signal propagation time from a Tx antenna reference point of a transmitter (e.g., a TRP or a UE) to an Rx antenna reference point of the receiver (e.g., a UE or a TRP). The propagation time can be expressed in a fractional part of a cycle of the RF frequency and a number of integer cycles, but the CP may be independent of the number of integer cycles.

In one or more implementations, the use of PRUs to facilitate NR carrier phase positioning is considered.

In one or more implementations, the existing DL PRS and UL SRS for positioning can be re-used as the reference signals to enable positioning based on NR carrier phase measurements for both UE-based and UE-assisted positioning. In one or more implementations enhancements of the existing DL PRS and UL SRS for better positioning performance is considered.

In one or more implementations, for UE-assisted or UE-based NR carrier phase positioning, at least one of the following options is considered: the difference between the carrier phase measured from the DL PRS signal(s) of the target TRP and the carrier phase measured from the DL PRS signal(s) of the reference TRP, and the carrier phase measured from the DL PRS signal(s) of a TRP.

In one or more implementations, the benefits of using the carrier phase measurements of multiple DL positioning frequency layers for NR carrier phase positioning, which may include the impact of the time gap between the carrier phase measurements of multiple DL PFLs, is considered. The initial phase error and the frequency error for each PFLs can be modelled independently. The PRS signals of all PFLs of a TRP can be assumed to be transmitted from the same antenna reference point (ARP) or from different ARPs of the TRP. The location error for ARPs can be modelled independently. The timing errors of the PFLs may not be the same for PFLs in different bands or frequency ranges. In one or more implementations, simultaneous reception of DL PRS from multiple frequency layers is not being supported in Rel-17 is considered.

In one or more implementations, for UL UE-assisted NR carrier phase positioning, the carrier phase measured from the UL SRS is considered for positioning purpose. The use of multiple-input multiple-output (MIMO) SRS for positioning purpose may be transparent to UE.

In one or more implementations, the impact of multipath/non-line-of-sight (NLOS) on NR carrier phase positioning is considered. Additionally or alternatively, multipath/NLOS deteriorating the performance of carrier phase positioning and multipath mitigation for NR carrier phase positioning is considered.

In one or more implementations, regarding error modelling, the initial phases of a transmitter for different carriers can be assumed to be independent of each other is considered. Similarly, the initial phases of a receiver for different carriers can be assumed to be independent of each other is considered.

In one or more implementations, the effectiveness of the following multipath mitigation methods for the carrier phase positioning and the potential on the standard work is considered. For example, identifying and separating the first path and other paths may be considered. By way of another example, reporting of the carrier phase of the first path, and optionally, the additional paths may be considered. By way of another example, the use of line-of-sight (LOS)/NLOS indication for the carrier phase measurements may be considered (e.g., Rel-17 LOS/NLOS indicator can be considered as a starting point). By way of another example, the report of other channel information, such as RSRP/RSRPP, is considered.

In one or more implementations, the at least one of the following approaches for NR carrier phase positioning, and identify the potential impact on the standard are considered: the reporting of the carrier phase measurements together with the existing positioning measurements, and the reporting of the carrier phase-based measurements alone without reporting the existing positioning measurements.

In one or more implementations, an initiator device initiates a SL positioning/ranging session, and may be a network entity, (e.g., gNB, LMF) or UE/roadside unit (RSU).

In one or more implementations, a responder device responds to a SL positioning/ranging session from an initiator device, and may be a network entity, (e.g., gNB, LMF) or UE/roadside unit (RSU).

In one or more implementations, a target-UE (or target UE) may be referred to as a UE of interest whose position (absolute or relative) is to be obtained by the network or by the UE itself (e.g., using SL, e.g., PC5 interface).

In one or more implementations, sidelink positioning refers to positioning a UE using reference signals transmitted over SL, e.g., PC5 interface, to obtain absolute position, relative position, or ranging information.

In one or more implementations, ranging refers to a determination of the distance and/or the direction between a UE and another entity, e.g., an anchor UE.

In one or more implementations, an anchor UE refers to a UE supporting positioning of a target UE, e.g., by transmitting and/or receiving reference signals for positioning, providing positioning-related information, etc., over the SL interface. The anchor UE may also be referred to as a reference UE or SL reference UE.

In one or more implementations, an assistant UE refers to a UE supporting ranging/sidelink between a SL reference UE and target UE over SL (e.g., PC5 interface), when the direct ranging/sidelink positioning between the SL reference UE/anchor UE and the target UE cannot be supported. The measurement/results of the ranging/sidelink positioning between the assistance UE and the SL reference UE and that between the assistance UE and the target UE are determined and used to derive the ranging/sidelink positioning results between target UE and SL reference UE.

In one or more implementations, a SL positioning server UE refers to a UE offering location calculation, for SL positioning and ranging based service. The SL positioning server UE interacts with other UEs over SL (e.g., PC5 interface) as necessary in order to calculate the location of the target UE. The target UE or SL reference UE can act as a SL positioning server UE if location calculation is supported.

In one or more implementations, a SL positioning client UE refers to a third-party UE, other than SL reference UE and target UE, which initiates ranging/sidelink positioning service request on behalf of the application residing on it. The SL positioning client UE does not have to support ranging/sidelink positioning capability, but a communication between the SL positioning client UE and SL reference UE/target UE is established, e.g., via PC5 or 5GC, for the transmission of the service request and the result.

In one or more implementations, a SL positioning node may refer to a network entity and/or device/UE participating in a SL positioning session, e.g., LMF (location server), gNB, UE, RSU, anchor UE, initiator and/or responder UE.

In one or more implementations, a configuration entity refers to a node network node or device/UE capable of configuring time-frequency resources and related SL positioning configurations. A SL positioning server UE may serve as a configuration entity.

In one or more implementations, a configuration entity refers to a network node or device (e.g., UE) capable of configuring time-frequency resources and related SL positioning configurations. A SL Positioning Server UE may serve as a configuration entity.

Various solutions for implementing carrier phase positioning reporting are discussed herein. One solution discussed herein is supporting the different types of DL and SL carrier phase measurement reporting according to the requested reporting configuration. Another solution discussed herein is supporting the different types of UL carrier phase measurement reporting according to the requested reporting configuration. Another solution discussed herein is enabling awareness of devices capable of supporting carrier phase measurements over the Uu or PC5. Another solution discussed herein is supporting error report notification relating to misconfigured DL or SL carrier phase configurations and/or inaccurate or faulty measurements.

The various solutions discussed herein may be implemented in combination with each other to support NR RAT-dependent positioning methods over the SL (e.g., PC5) interface.

A positioning-related reference signal may be referred to as a reference signal used for positioning procedures or purposes in order to estimate a target-UE's location, e.g., PRS, or based on existing reference signals such as channel state information reference signal (CSI-RS) or SRS; a target-UE may be referred to as the device or entity to be localized or positioned. In various implementations, the term “PRS” may refer to any signal such as a reference signal, which may or may not be used primarily for positioning.

References made to position or location information may refer to either an absolute position, relative position with respect to another node or entity, ranging in terms of distance, ranging in terms of direction, or a combination thereof.

In one or more implementations, various reporting configurations can be transmitted by a configuration entity in order to enable different methods of reporting the DL and SL carrier phase measurements. These reporting methods also include any location information derived solely on carrier phase measurements or jointly based on other DL or SL positioning measurements, e.g., DL-RSTD, UE Rx-Tx time difference measurements, DL PRS RSRPP/RSRP, SL PRS RSRP/RSRPP, SL-AoA, SL RSTD, SL-RTOA and so forth.

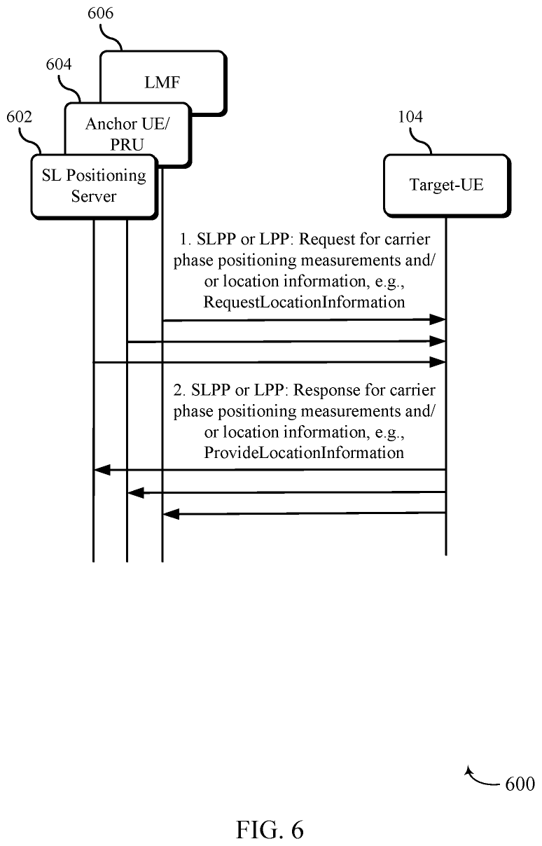

FIG. 6 illustrates an example of DL or SL carrier phase measurement request and response report messaging 600 as related to carrier phase positioning reporting in accordance with aspects of the present disclosure. The messaging 600 shows the request and response signaling between a configuration entity and a target-UE 104 exchanging the carrier phase related report measurements. The configuration entity may be at least one of a SL positioning server UE 602, an anchor UE or PRU 604, and a LMF 606. According to the messaging 600 illustrated in FIG. 6, the carrier phase measurement request and response report messaging may be signaled using LTE positioning protocol (LPP) for DL carrier phase measurements, e.g., using the LPP RequestLocationInformation and/or LPP ProvideLocationInformation messages or using SLPP (SL positioning protocol) for SL carrier phase measurements, e.g., using the SLPP RequestLocationInformation and/or SLPP ProvideLocationInformation messages. On SL, such reporting configuration messages may be sent using security via unicast, groupcast or broadcast messages. The security may comprise integrity and cipher protection.

According to the messaging 600, the messaging to request and report DL or SL carrier phase measurements is as follows. Any one of an entity or node (e.g., the LMF 606, the anchor or PRU UE 604, the SL Positioning server 602 (e.g., a sidelink Positioning server UE) may request the target-UE 104 to provide multiple carrier phase measurements. The target-UE 104 may respond in kind to any one of an entity or node (e.g., the LMF 606, the anchor or PRU UE 604, the SL Positioning server UE 602) with one or more sets of a carrier phase measurements as well as assistance information to help process the carrier phase measurements. The target-UE 104 may respond to the same entity or node as request was received from or a different entity or node. For example, the target-UE 104 may receive the request to provide multiple carrier phase measurements from the SL positioning server 602, and respond by transmitting the multiple carrier phase measurements to the LMF 606.

Additionally or alternatively, in case of UE-based positioning, the target-UE 104 may request DL or SL carrier phase measurements from the PRU via the above-described request signaling mechanisms. The target-UE 104 may request DL or SL carrier phase measurements directly from the PRU via SLPP signaling, or the target-UE may request PRU carrier phase measurements via LPP using the gNB and LMF. The LMF may, for example, respond to the request by providing PRU carrier phase measurements via the LPP ProvideAssistanceData or RequestLocationInformation message or via new or existing positioning system information broadcast signaling (posSIBs) to multiple target-UEs. Information that may be associated to each PRU carrier phase measurement may include carrier frequency information, PRU integer ambiguity information, e.g., value ranges and quality metrics, SCS, positioning frequency layer information, PRS resource IDs, PRS resource set IDs, TRP IDs, PRU identifying information such as PRU IDs, LOS/NLOS information (hard or soft indicators) related to each of the carrier phase measurements, additional path information related to each of the carrier phase measurements, PRU receiver error type information including any oscillator drift, clock drift, initial PRU phase offsets or group of phase offsets, PRU ARP location error, PRU phase center offset information, PRU measurement time stamp information, carrier phase and/or timing measurement quality metrics or the like. The reported carrier phase measurements may originate from one or more PRUs in the vicinity of the target-UE.

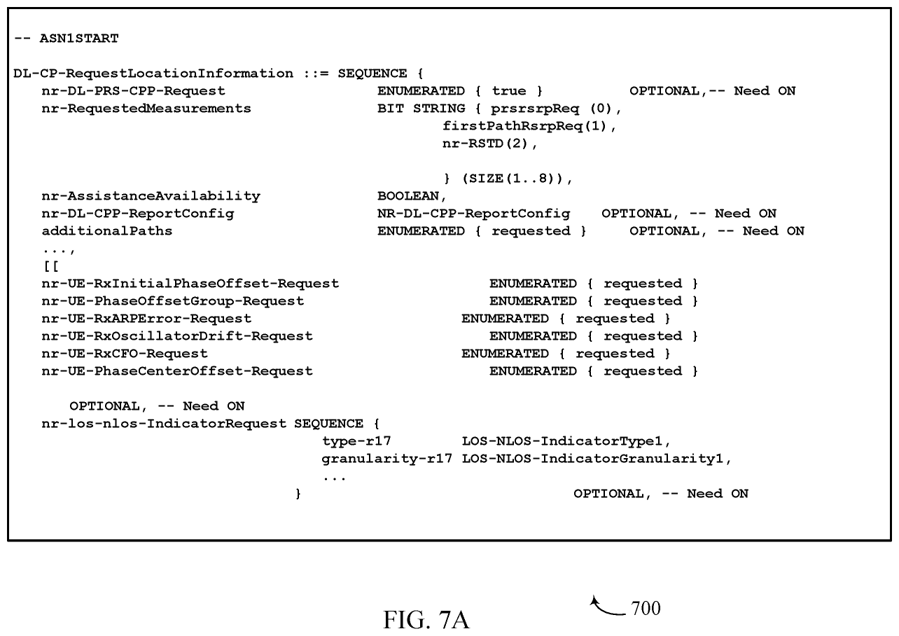

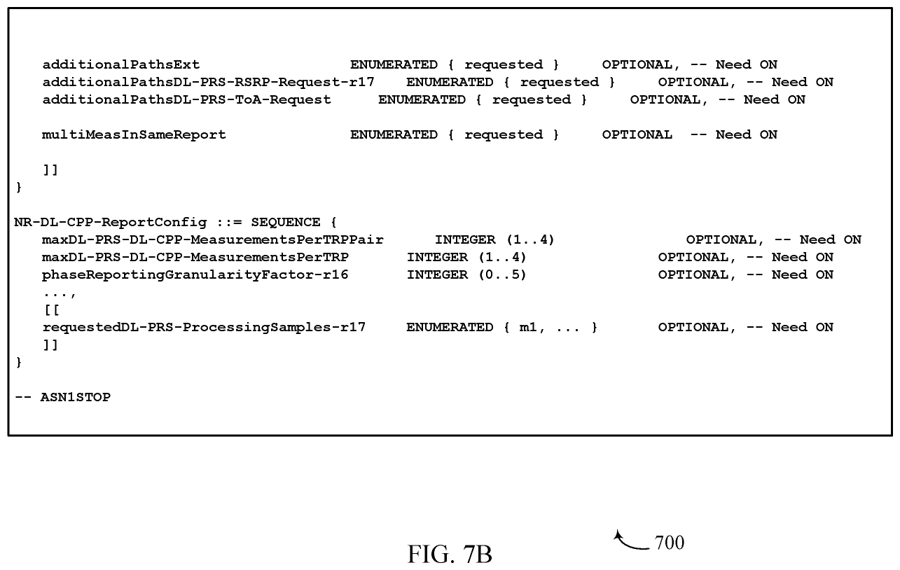

FIGS. 7A and 7B illustrate an example request information element (IE) message 700 as related to carrier phase positioning reporting in accordance with aspects of the present disclosure. The IE message 700 is an example of an NR-DL-CP-RequestLocationInformation IE message (e.g., transmitted from a SL positioning server 602, an anchor UE or PRU 604, or an LMF 606 to a target UE 104 as illustrated in FIG. 6). The IE message 700 illustrates the different elements, components, and associated descriptions used to support DL carrier phase positioning measurement reporting.

The NR-DL-CP-RequestLocationInformation IE message 700 includes several fields as discussed in more detail below.

An nr-AssistanceAvailability field indicates whether the target device may request additional PRS assistance data from the server. TRUE means allowed and FALSE means not allowed. The nr-AssistanceAvailability field may also indicate if on-demand PRS for carrier phase positioning may be supported.

An nr-DL-PRS-CPP-Request field indicates whether the target device is requested to report DL-PRS Resource ID(s) or DL-PRS Resource Set ID(s) associated with each DL carrier phase measurement per positioning frequency layer.

An nr-RequestedMeasurements field specifies the additional NR positioning measurements requested, e g., RSRP, RSTD, ToA, etc. In one or more implementations, this is represented by a bit string, with a one-value at the bit position meaning the particular measurement is requested; a zero-value means not requested.

An additionalPaths field, if present, indicates that the target device is requested to provide the nr-AdditionalPathList in a Carrier phase measurement report. If this field is present, the field additionalPathsExt is absent.

An nr-UE-RxInitialPhaseOffset-Request field, if present, indicates that the target device is requested to provide the Rx initial phase offset in the DL carrier phase measurement report.

An nr-UE-PhaseOffsetGroup-Request field, if present, indicates that the target device is requested to provide the Rx phase offset group in the DL carrier phase measurement report for all DL PRS resources within a small margin.

An nr-UE-RxARPError-Request field, if present, indicates that the target device is requested to provide the Rx antenna reference point error in the DL carrier phase measurement report.

An nr-UE RxOscillatorDrift-Request field, if present, indicates that the target device is requested to provide the Rx oscillator drift in the DL carrier phase measurement report.

An nr-UE-RxCFO-Request field, if present, indicates that the target device is requested to provide the Rx carrier frequency offset in the DL carrier phase measurement report.

An nr-UE-RxPhaseCenterOffset-Request field, if present, indicates that the target device is requested to provide the Rx antenna phase center offset in the DL carrier phase measurement report.

An nr-los-nlos-IndicatorRequest field, if present, indicates that the target device is requested to provide the indicated type and granularity of the estimated LOS-NLOS-Indicator in the DL carrier phase measurement report.

An additionalPathsExt field, if present, indicates that the target device is requested to provide the nr-AdditionalPathListExt in the DL carrier phase measurement report. If this field is present, the field additionalPaths is absent.

An additionalPathsDL-PRS-RSRP-Request field, if present, indicates that the target device is requested to provide the nr-DL-PRS-RSRPP for the additional paths in IE NR-AdditionalPathList.

A multiMeasInSameReport field, if present, indicates that the target device is requested to provide multiple measurement instances in a single measurement report; e.g., include the nr-DL-CPP-SignalMeasurementInstances (in the case of UE-assisted mode is requested) or nr-DL-CPP-LocationInformationInstances (in the case of UE-based mode is requested) in IE NR-DL-CPP-ProvideLocationInformation.

A maxDL-PRS-CPP-MeasurementsPerTRPPair field specifies the maximum number of. DL-PRS DL carrier phase measurements per pair of TRPs. The maximum number is defined across all Positioning Frequency Layers. The carrier phase difference is then obtained per pair of TRPs and may be subject to UE capability.

A maxDL-PRS-DL-CPP-MeasurementsPerTRP field specifies the maximum number of DL-carrier phase measurements from the same TRP. The maximum number is defined across all Positioning Frequency Layers and may be subject to UE capability.

A phaseReportingGranularityFactor field specifies the recommended reporting granularity for the DL carrier phase measurements. The UE may select different granularity values or step values in terms of radians or degrees according to configured step values, e.g., [0, 0.1, . . . , 2pi]. Different step values may be configured to ease reporting overhead.

A requestedDL-PRS-ProcessingSamples field, if present, indicates the requested number of DL-PRS processing samples for performing DL carrier phase measurements. For example an enumerated value ‘ml’ indicates 1-sample DL-PRS processing is.

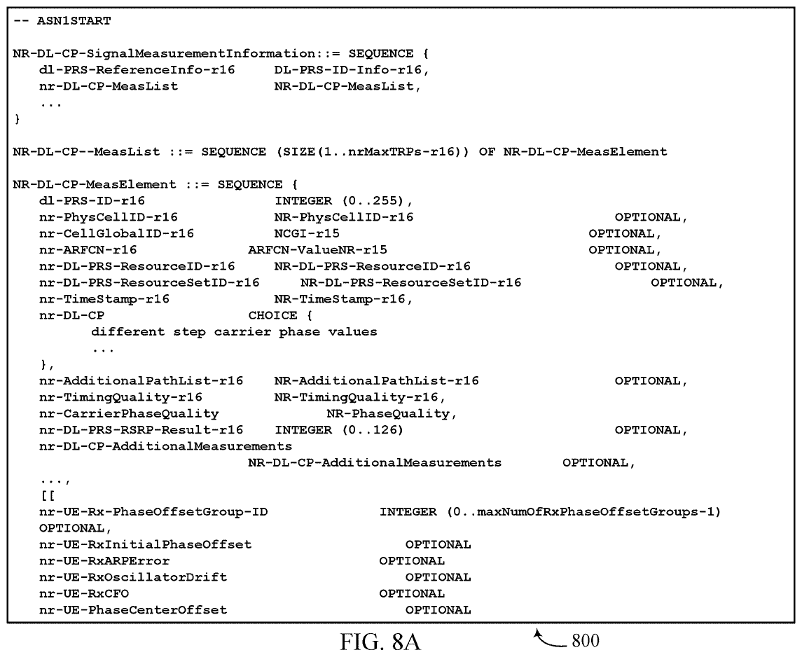

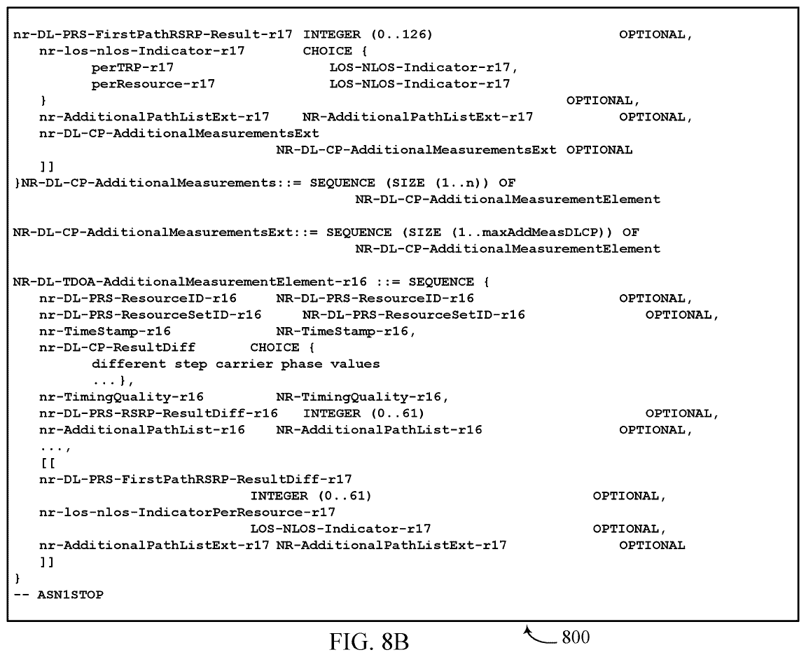

FIGS. 8A and 8B illustrate an example response IE message 800 as related to carrier phase positioning reporting in accordance with aspects of the present disclosure. The IE message 700 is an example of an NR-DL-CP-SignalMeasurementInformation IE message as part of the ProvideLocationInformation message (e.g., transmitted by the target-UE 104 of FIG. 6 to the LMF 606, the anchor UE/PRU 604, or the SL positioning server 602 of FIG. 6). The IE message 800 illustrates the different elements, components, and associated descriptions used to support DL carrier phase positioning measurement reporting.

The NR-DL-CP-SignalMeasurementInformation IE message 800 includes several fields as discussed in more detail below.

An nr-DL-PRS-RSRP-Result field specifies the NR DL-PRS reference signal received power (DL PRS-RSRP) measurement.

An nr-DL-PRS-FirstPathRSRP-Result field specifies the NR DL-PRS reference signal received path power (DL PRS-RSRPP) of the first detected path in time, as defined in 3GPP technical specification (TS) 38.215. The mapping of the measured quantity is defined as in 3GPP TS 38.133.

A dl-PRS-ID field is used along with a DL-PRS Resource Set ID and a DL-PRS Resources ID to uniquely identify a DL-PRS Resource. This ID can be associated with multiple DL-PRS Resource Sets associated with a single TRP. Each TRP should only be associated with one such ID.

An nr-PhysCellID field defines the physical cell identity of the associated TRP.

An nr-CellGlobalID field defines the NR cell global identifier (NCGI), the globally unique identity of a cell in NR, of the associated TRP, as defined in 3GPP TS 38.331.

An nr-ARFCN field defines the NR-ARFCN of the TRP's CD-SSB (as defined in 3GPP TS 38.300) corresponding to nr-PhysCellID.

An nr-TimeStamp field defines the time instance at which the DL carrier phase measurements, time of arrival (TOA) or DL PRS-RSRP/RSRPP (if included) measurement is performed. The nr-SFN and nr-Slot in IE NR-TimeStamp correspond to the TRP provided in dl-PRS-ReferenceInfo as specified in 3GPP TS 38.214. The TOA measurement refers to the TOA of this neighbor TRP or the reference TRP, as applicable. This can be reported in conjunction with nr-DL-CP or nr-DL-CP-ResultDiff IEs.

An nr-DL-CP field defines the carrier phase measurement of single positioning frequency layer. Additionally or alternatively, this field may also define the relative carrier phase difference between this neighbor TRP and the PRS reference TRP.

An nr-AdditionalPathList field specifies one or more additional carrier phase measurement path timing values for the TRP or resource, relative to the path timing used for determining the nr-DL-CP value. If this field was requested but is not included, it means the UE did not detect any additional path timing values. If this field is present, the field nr-AdditionalPathListExt is absent.

An nr-TimingQuality field defines the target device's best estimate of the quality of the TOA measurement.

An nr-CarrierPhaseQuality field defines the target device's best estimate of the quality of the DL carrier phase measurement. Additionally or alternatively, the DL carrier phase measurement refers to the DL carrier phase measurement of this neighbor TRP or the reference TRP, as applicable, used to determine the nr-DL-CP or nr-DL-CP-ResultDiff.

An nr-los-nlos-Indicator field specifies the target device's best estimate of the LOS or NLOS of the DL carrier phase measurement for the TRP or resource. Note, the DL carrier phase measurement refers to the DL carrier phase measurement of this neighbor TRP or the reference TRP, as applicable, used to determine This can be reported in conjunction with nr-DL-CP or nr-DL-CP-ResultDiff. This can be a hard (binary) indicator, while in another implementation a soft indicator may be used.

An nr-AdditionalPathListExt field provides up to 8 additional detected path timing values for the TRP or resource, relative to the path timing used for determining the nr-DL-CP value. In other implementation the maximum number of additional detected paths may be configurable to other values. If this field was requested but is not included, it means the UE did not detect any additional path timing values. If this field is present, the field nr-AdditionalPathList shall be absent.

An nr-DL-CP-ResultDiff field provides the additional DL carrier phase measurement result relative to nr-DL-CP. The DL carrier phase value of this measurement is obtained by adding the value of this field to the value of the nr-DL-CP field. This field provides any delta or difference reporting with respect to the previous reported DL carrier phase measurement and the current or latest DL carrier phase measurement.

An nr-DL-PRS-RSRP-ResultDiff field provides the additional DL-PRS RSRP measurement result relative to nr-DL-PRS-RSRP-Result. The DL-PRS RSRP value of this measurement is obtained by adding the value of this field to the value of the nr-DL-PRS-RSRP-Result field.

An nr-DL-PRS-FirstPathRSRP-ResultDiff field specifies the additional NR DL PRS reference signal received path power (DL PRS-RSRPP) of the first detected path in time relative to nr-DL-PRS-FirstPathRSRP-Result. The DL-PRS RSRPP of first path value of this measurement is obtained by adding the value of this field to the value of the nr-DL-PRS-FirstPathRSRP-Result field.

An nr-UE-RxInitialPhaseOffset field, if present, indicates the target device's initial phase offset in the DL carrier phase measurement report.

An nr-UE-PhaseOffsetGroup field, if present, indicates that the target device's phase offset group across different PRS resources from different beams/TRPs within a defined margin in the DL carrier phase measurement report for all DL PRS resources within a small margin.

An nr-UE-RxARPError field, if present, indicates that the target device's antenna reference point error in the DL carrier phase measurement report. This field can be characterized with a specific Rx ARP Error ID, the location type can be defined in terms of ARP Position Relative Geodetic or ARP Position Relative Cartesian coordinates

An nr-UE-RxOscillatorDrift field, if present, indicates that the target device's oscillator drift in the DL carrier phase measurement report.

An nr-UE-RxCFO field, if present, indicates that the target device's carrier frequency offset in the DL carrier phase measurement report.

An nr-UE-RxPhaseCenterOffset field, if present, indicates that the target device's antenna phase center offset in the DL carrier phase measurement report.

In one or more implementations, the above described reporting configuration given by NR-DL-CP-RequestLocationInformation can be extended to the SL carrier phase reporting configuration, e.g., defined by NR-SL-CP-RequestLocationInformation. Similarly, the above described DL carrier phase measurement report given by NR-DL-CP-SignalMeasurementInformation can be extended to the SL carrier phase measurement report, e.g., defined by NR-SL-CP-SignalMeasurementInformation.

Additionally or alternatively, the reporting types applicable for carrier phase measurement may be configured as one-shot reporting, periodic reporting, event triggered reporting, or a combination thereof. One shot reporting is also referred to as immediate reporting, where the target device is requested to report the carrier phase measurements immediately as soon it is ready or available. Periodic reporting of the carrier phase measurements may also be configured with a configured reporting amount and reporting interval or periodicity. Additionally or alternatively, the reporting may also be semi-persistent with activation and deactivation commands using lower signaling, e.g., RRC or MAC CE. Even triggered reporting may also be supported for carrier phase measurements, depending on certain configured events such as tracking area change, cell change, ran notification area change, zone change, horizontal or vertical relative distance exceeding a certain threshold, timer expiration, each of which may associated with a reporting duration indicating the maximum duration of the triggered reporting in seconds.

In one or more implementations, various reporting configurations can be transmitted by a configuration entity, e.g., an LMF to a serving or neighboring gNBs/TRPs in order to enable different methods of reporting the UL carrier phase measurements. These reporting methods also include any location information derived solely on carrier phase measurements or jointly based on other UL positioning measurements, e.g., UL-RTOA, UL-AoA, gNB Rx-Tx time difference measurement and so forth.

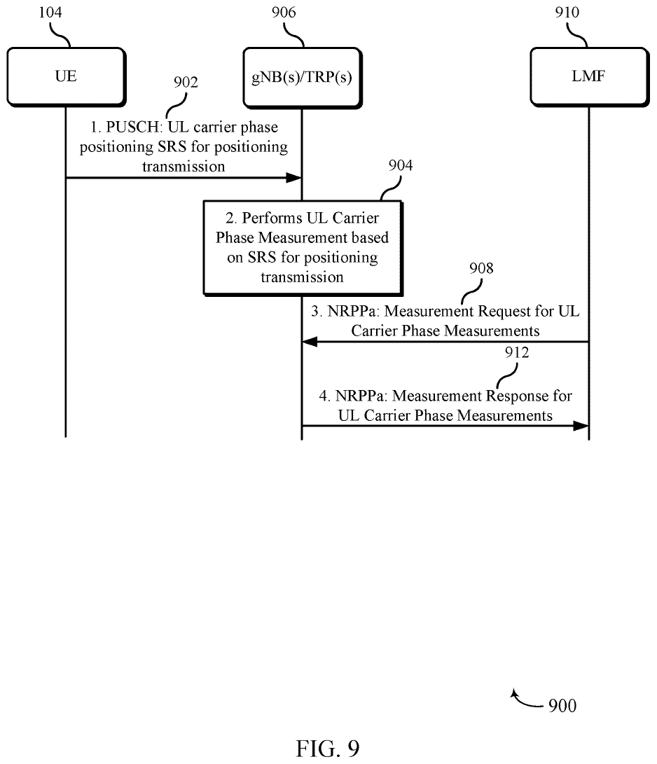

FIG. 9 illustrates an example of UL carrier phase measurement request and response report messaging 900 as related to carrier phase positioning reporting in accordance with aspects of the present disclosure. The messaging 900 is the request and response signaling between a configuration entity and target-UE exchanging the UL carrier phase related report measurements. As illustrated in FIG. 9, the UL carrier phase measurement request and response report messaging may be signaled using NRPPa for UL carrier phase measurements, e.g., using the NRPPa MeasurementRequest and/or NRPPa MeasurementResponse messages.

As illustrated in FIG. 9, the steps to request and report UL carrier phase measurements are described as follows.

At 902, the UE 104 transmits multiple SRS for positioning signals for the measurement of the UL carrier phase. This can be based on a single carrier transmission or if configured, multiple carrier transmissions.

At 904, the serving gNB or TRP 906 performs the UL carrier phase measurements based on the provided SRS configuration. In other implementations MIMO for SRS may also be used at 902 and 904 for the UL carrier phase measurement.

At 908, an LMF 910 may request the multiple gNBs/TRPs 906 to provide a plurality of carrier phase measurements via a list or index. The reporting may be performed in a one-shot, periodic or event-triggered manner. The request may also include parameters related to the gNB/TRP beam information of the requested carrier phase measurements, reporting granularity or step values of the carrier phase in radians or degrees, number of error types, if known to the gNB/TRP including receiver initial phase offset, gNB ARP location error, oscillator drift or clock offset, carrier frequency offset, antenna phase offset or combination thereof.

At 912, the multiple gNBs/TRPs may respond with the UL carrier phase measurement result comprising of additional parameters such as the UL carrier phase measurement quality, e.g., single quality metric, confidence intervals. In case of unavailability or errors in performing UL carrier phase measurements, the gNB/TRP may respond with the measurement failure of UL carrier phase measurement.

In one or more implementations, carrier phase capability exchange is supported. Any one of an entity/node, e.g., LMF, Anchor/PRU UE, SL Positioning server UE, and target-UE may exchange capability related messages in order to perform DL or SL carrier phase measurements. Such capabilities may be dynamic or static based on the UE type. These capability related messages may be, for example, capability request and response messages.

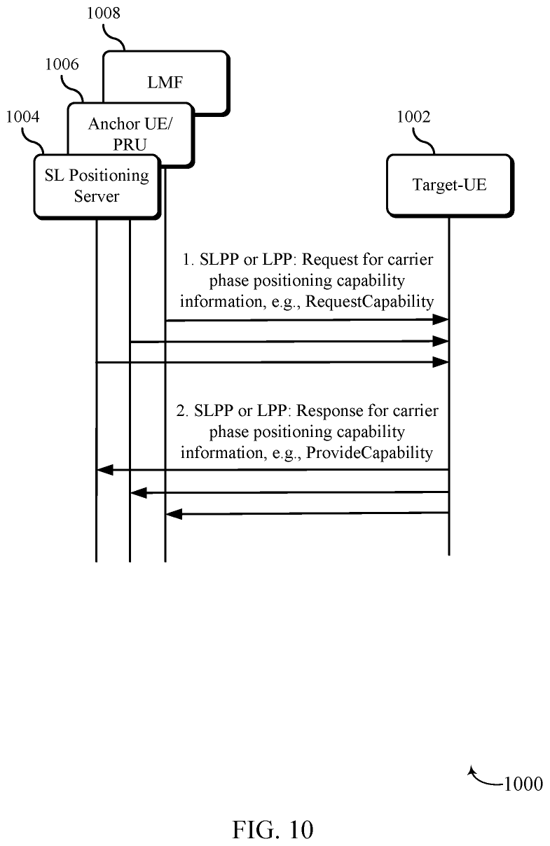

FIG. 10 illustrates an example of DL or SL Carrier phase capability exchange messages 1000 as related to carrier phase positioning reporting in accordance with aspects of the present disclosure. The messages 1000 are the request and response signaling between a configuration entity and target-UE 1002 exchanging the carrier phase related capability messages. The configuration entity may be at least one of a SL positioning server UE 1004, an anchor UE or PRU 1006, and a LMF 1008. According to the messaging illustrated in FIG. 10, the carrier phase capability request and response report messaging may be signaled using LPP for DL carrier phase measurements, e.g., using the LPP RequestCapabilityInformation and/or LPP ProvideCapabilityInformation messages or using SLPP (SL positioning protocol) for SL carrier phase measurements, e.g., using the SLPP RequestCapabilityInformation and/or SLPP ProvideCapabilityInformation messages. On SL, such capability messages may be sent using security via unicast, groupcast or broadcast messages. The security may comprise integrity and cipher protection.

According to the messages 1000, the messaging to request and report SL or DL carrier phase measurements is as follows. Any one of an entity or node (e.g., the LMF 1008, the Anchor or PRU UE 1006, the SL Positioning server UE 1004) may request the target-UE 1002 to provide a plurality of carrier phase capabilities. The target-UE 1002 may respond in kind to any one of an entity/node, (e.g., the LMF 1008, the Anchor or PRU UE 1006, the SL Positioning server UE 1004) with one or more sets of a carrier phase capabilities.

In one or more implementations, carrier phase error causes are supported. The target UE or configuration entity may provide DL or SL carrier phase positioning error causes. The error causes related to carrier phase positioning may vary depending on the source and type of error.

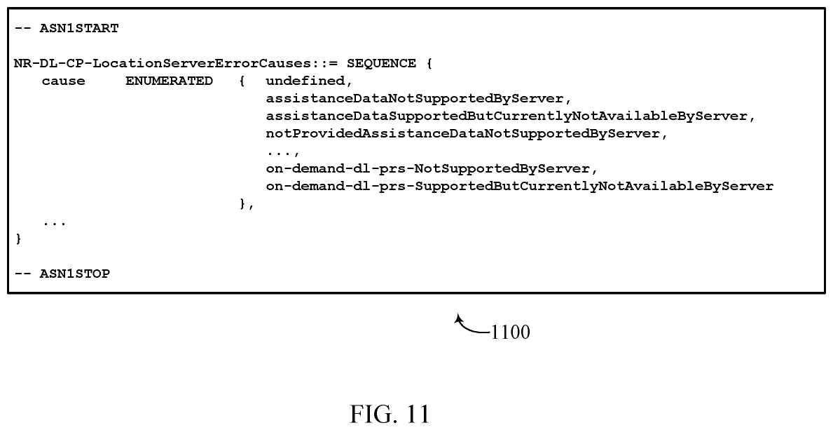

FIG. 11 illustrates an example IE message 1100 as related to carrier phase positioning reporting in accordance with aspects of the present disclosure. The IE message 1100 shows the supported error causes by the configuration entity, which can be conveyed via LPP. The IE message 1100 is an example of an NR-DL-CP-LocationServerErrorCauses message that is used by the location server to provide NR DL carrier phase measurement error reasons to the target device. This may also be equally applicable to SL configuration entities providing such error causes to the target-UE/device.

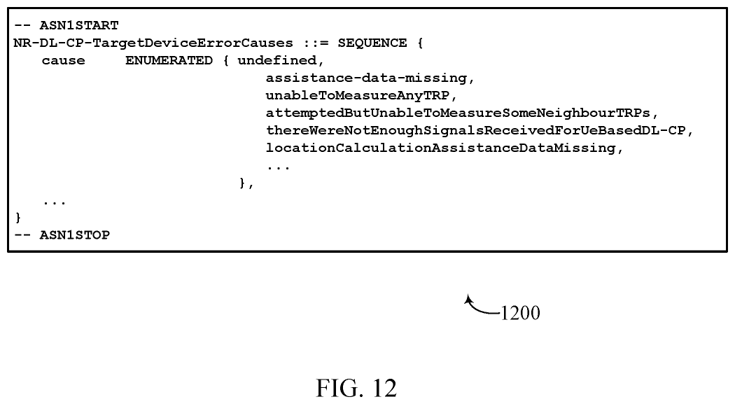

FIG. 12 illustrates an example IE message 1200 as related to carrier phase positioning reporting in accordance with aspects of the present disclosure. The IE message 1200 shows the supported error causes by the target-UE, which can be conveyed via LPP. The IE message 1200 is an example of an NR-DL-CP-TargetDeviceErrorCauses message that is used by the target-UE to provide NR DL carrier phase measurement error reasons to the location server. This may also be equally applicable to the SL target-UE/device providing the above error causes to the SL configuration entities.

Accordingly, the techniques discussed herein provide a set of solutions to support the reporting of carrier phase measurement through appropriate reporting configurations. One aspect of the solution involves the efficient reporting of DL, SL and UL carrier phase measurements including the reporting of error types including phase offsets, ARP location errors, oscillator drifts or clock offsets, CFO, and antenna phase center offsets. A further aspect of the solution involves procedures to exchange capability messages and error causes related to both DL and SL carrier phase measurements.

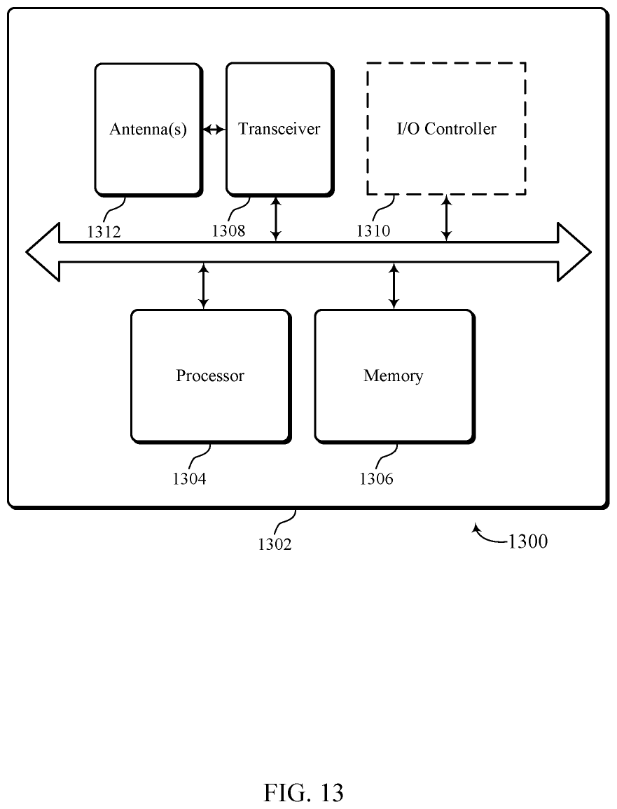

FIG. 13 illustrates an example of a block diagram 1300 of a device 1302 that supports carrier phase positioning reporting in accordance with aspects of the present disclosure. The device 1302 may be an example of a UE 104 as described herein. The device 1302 may support wireless communication with one or more network entities 102, UEs 104, or any combination thereof. The device 1302 may include components for bi-directional communications including components for transmitting and receiving communications, such as a processor 1304, a memory 1306, a transceiver 1308, and an I/O controller 1310. These components may be in electronic communication or otherwise coupled (e.g., operatively, communicatively, functionally, electronically, electrically) via one or more interfaces (e.g., buses).

The processor 1304, the memory 1306, the transceiver 1308, or various combinations thereof or various components thereof may be examples of means for performing various aspects of the present disclosure as described herein. For example, the processor 1304, the memory 1306, the transceiver 1308, or various combinations or components thereof may support a method for performing one or more of the operations described herein.

In some implementations, the processor 1304, the memory 1306, the transceiver 1308, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 1304 and the memory 1306 coupled with the processor 1304 may be configured to perform one or more of the functions described herein (e.g., executing, by the processor 1304, instructions stored in the memory 1306).

For example, the processor 1304 may support wireless communication at the device 1302 in accordance with examples as disclosed herein. Processor 1304 may be configured as or otherwise support to: receive, from a configuration entity, a first signaling indicating a carrier phase positioning reporting configuration, where the carrier phase positioning reporting configuration includes at least a set of receiver error types and a carrier phase granularity; generate multiple carrier phase measurement reports that include multiple carrier phase positioning measurements based on the received reporting configuration; transmit, to a configuration entity, multiple second signalings indicating the multiple carrier phase measurement reports.

For example, the processor 1304 may support wireless communication at the device 1302 in accordance with examples as disclosed herein. Processor 1304 may be configured as or otherwise support to: receive, from a configuration entity, a first signaling indicating a carrier phase positioning reporting configuration, where the carrier phase positioning reporting configuration includes at least a carrier phase granularity; generate multiple carrier phase measurement reports that include multiple carrier phase positioning measurements based on the received reporting configuration; transmit, to a configuration entity, multiple second signalings indicating the multiple carrier phase measurement reports.

Additionally or alternatively, the processor 1304 may be configured to or otherwise support: where the carrier phase reporting configuration further includes a request to provide additional RAT-dependent positioning measurements including at least one of a DL-RSTD, a UE Rx-Tx time difference, a DL PRS RSRP, a DL PRS RSRPP, a SL-RSTD, a SL-RTOA, a SL PRS RSRP, a SL PRS RSRPP, or a SL-AoA; where the carrier phase positioning reporting configuration includes a set of receiver error types including at least one of an initial phase offset, an initial phase offset group, a UE antenna reference point location error, an oscillator drift or clock offset, a carrier frequency offset, and an antenna phase center offset; where each of the error types is associated with an identifier; where the carrier phase positioning measurements are reported in the carrier phase measurement reports per TRP in a form of a plurality of single carrier phase measurements or per pair of TRPs in a form of a plurality of reference signal carrier phase difference measurements; where the carrier phase positioning measurements are reported in the carrier phase measurement reports based on a defined granularity or step values in terms of radians or degrees; where the carrier phase positioning measurements are reported in the carrier phase measurement reports based on a defined quality metric; where a delta or difference carrier phase measurement is reported in the carrier phase measurement reports with respect to a previously performed carrier phase positioning measurement and a current carrier phase measurement; where the processor is further configured to cause the apparatus to transmit, to the configuration entity, an apparatus error cause related to carrier phase positioning; where the processor is further configured to cause the apparatus to receive a configuration entity error cause related to carrier phase positioning; where the processor is further configured to cause the apparatus to support, via capability request and response messages, awareness of devices capable of supporting carrier phase measurements; where the apparatus comprises a UE; where the processor is further configured to cause the apparatus to transmit a request for PRU carrier phase measurements and/or associated information, and receive a response of PRU carrier phase measurements and/or associated information in a case of UE-based positioning; where the associated information includes at least one of PRU integer ambiguity information and quality metrics PRS resource IDs, PRS resource set IDs, TRP IDs, PRU identifying information, PRU IDs, LOS/NLOS information related to each of the carrier phase positioning measurements, additional path information related to each of the carrier phase positioning measurements, PRU receiver error type information including any oscillator drift, clock drift, initial PRU phase offsets or group of phase offsets, PRU ARP location error, PRU phase center offset, PRU measurement time stamp information, or carrier phase or timing measurement quality metrics.

For example, the processor 1304 may support wireless communication at the device 1302 in accordance with examples as disclosed herein. Processor 1304 may be configured as or otherwise support a means for receiving, from a configuration entity, a first signaling indicating a carrier phase positioning reporting configuration, where the carrier phase positioning reporting configuration includes at least a set of receiver error types and a carrier phase granularity; generating multiple carrier phase measurement reports that include multiple carrier phase positioning measurements based on the received reporting configuration; and transmitting, to a configuration entity, multiple second signalings indicating the multiple carrier phase measurement reports.

For example, the processor 1304 may support wireless communication at the device 1302 in accordance with examples as disclosed herein. Processor 1304 may be configured as or otherwise support a means for receiving, from a configuration entity, a first signaling indicating a carrier phase positioning reporting configuration, where the carrier phase positioning reporting configuration includes at least a carrier phase granularity; generating multiple carrier phase measurement reports that include multiple carrier phase positioning measurements based on the received reporting configuration; and transmitting, to a configuration entity, multiple second signalings indicating the multiple carrier phase measurement reports.

Additionally or alternatively, the processor 1304 may be configured to or otherwise support: where the carrier phase reporting configuration further includes a request to provide additional RAT-dependent positioning measurements including at least one of a DL-RSTD, a UE Rx-Tx time difference, a DL PRS RSRP, a DL PRS RSRPP, a SL-RSTD, a SL-RTOA, a SL PRS RSRP, a SL PRS RSRPP, or a SL-AoA; where the carrier phase positioning reporting configuration includes a set of receiver error types that include at least one of an initial phase offset, an initial phase offset group, a UE antenna reference point location error, an oscillator drift or clock offset, a carrier frequency offset, and an antenna phase center offset; where each of the error types is associated with an identifier; where the carrier phase positioning measurements are reported in the carrier phase measurement reports per TRP in a form of a plurality of single carrier phase measurements or per pair of TRPs in a form of a plurality of reference signal carrier phase difference measurements; where the carrier phase positioning measurements are reported in the carrier phase measurement reports based on a defined granularity or step values in terms of radians or degrees; where the carrier phase positioning measurements are reported in the carrier phase measurement reports based on a defined quality metric; where a delta or difference carrier phase measurement is reported in the carrier phase measurement reports with respect to a previously performed carrier phase positioning measurement and a current carrier phase measurement; further including transmitting, to the configuration entity, an apparatus error cause related to carrier phase positioning; further including receiving a configuration entity error cause related to carrier phase positioning; further including supporting, via capability request and response messages, awareness of devices capable of supporting carrier phase measurements; where the method is implemented in a user equipment; further including transmitting a request for PRU carrier phase measurements and/or associated information, and receiving a response of PRU carrier phase measurements and/or associated information in a case of UE-based positioning; where the associated information includes at least one of PRU integer ambiguity information and quality metrics PRS resource IDs, PRS resource set IDs, TRP IDs, PRU identifying information, PRU IDs, LOS/NLOS information related to each of the carrier phase positioning measurements, additional path information related to each of the carrier phase positioning measurements, PRU receiver error type information including any oscillator drift, clock drift, initial PRU phase offsets or group of phase offsets, PRU ARP location error, PRU phase center offset, PRU measurement time stamp information, or carrier phase or timing measurement quality metrics.

The processor 1304 of the device 1302, such as a UE 104, may support wireless communication in accordance with examples as disclosed herein. The processor 404 includes at least one controller coupled with at least one memory, and is configured to or operable to cause the processor to receive, from a configuration entity, a first signaling indicating a carrier phase positioning reporting configuration, wherein the carrier phase positioning reporting configuration includes at least a set of receiver error types and a carrier phase granularity; generate multiple carrier phase measurement reports that include multiple carrier phase positioning measurements based on the received reporting configuration; transmit, to a configuration entity, multiple second signalings indicating the multiple carrier phase measurement reports.

The processor 1304 of the device 1302, such as a UE 104, may support wireless communication in accordance with examples as disclosed herein. The processor 404 includes at least one controller coupled with at least one memory, and is configured to or operable to cause the processor to receive, from a configuration entity, a first signaling indicating a carrier phase positioning reporting configuration, wherein the carrier phase positioning reporting configuration includes at least a carrier phase granularity; generate multiple carrier phase measurement reports that include multiple carrier phase positioning measurements based on the received reporting configuration; transmit, to a configuration entity, multiple second signalings indicating the multiple carrier phase measurement reports.

The processor 1304 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 1304 may be configured to operate a memory array using a memory controller. In some other implementations, a memory controller may be integrated into the processor 1304. The processor 1304 may be configured to execute computer-readable instructions stored in a memory (e.g., the memory 1306) to cause the device 1302 to perform various functions of the present disclosure.

The memory 1306 may include random access memory (RAM) and read-only memory (ROM). The memory 1306 may store computer-readable, computer-executable code including instructions that, when executed by the processor 1304 cause the device 1302 to perform various functions described herein. The code may be stored in a non-transitory computer-readable medium such as system memory or another type of memory. In some implementations, the code may not be directly executable by the processor 1304 but may cause a computer (e.g., when compiled and executed) to perform functions described herein. In some implementations, the memory 1306 may include, among other things, a basic I/O system (BIOS) which may control basic hardware or software operation such as the interaction with peripheral components or devices.

The I/O controller 1310 may manage input and output signals for the device 1302. The I/O controller 1310 may also manage peripherals not integrated into the device 1302. In some implementations, the I/O controller 1310 may represent a physical connection or port to an external peripheral. In some implementations, the I/O controller 1310 may utilize an operating system such as iOS®, ANDROID®, MS-DOS®, MS-WINDOWS®, OS/2®, UNIX®, LINUX®, or another known operating system. In some implementations, the I/O controller 1310 may be implemented as part of a processor, such as the processor 1304. In some implementations, a user may interact with the device 1302 via the I/O controller 1310 or via hardware components controlled by the I/O controller 1310.

In some implementations, the device 1302 may include a single antenna 1312. However, in some other implementations, the device 1302 may have more than one antenna 1312 (i.e., multiple antennas), including multiple antenna panels or antenna arrays, which may be capable of concurrently transmitting or receiving multiple wireless transmissions. The transceiver 1308 may communicate bi-directionally, via the one or more antennas 1312, wired, or wireless links as described herein. For example, the transceiver 1308 may represent a wireless transceiver and may communicate bi-directionally with another wireless transceiver. The transceiver 1308 may also include a modem to modulate the packets, to provide the modulated packets to one or more antennas 1312 for transmission, and to demodulate packets received from the one or more antennas 1312.

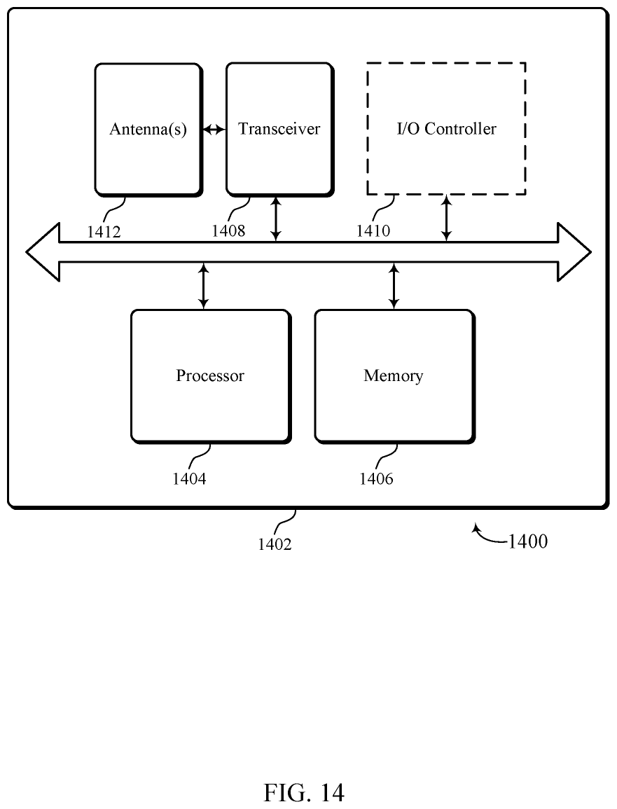

FIG. 14 illustrates an example of a block diagram 1400 of a device 1402 that supports carrier phase positioning reporting in accordance with aspects of the present disclosure. The device 1402 may be an example of a network entity 102 (e.g., a configuration entity or LMF) as described herein. The device 1402 may support wireless communication with one or more network entities 102, UEs 104, or any combination thereof. The device 1402 may include components for bi-directional communications including components for transmitting and receiving communications, such as a processor 1404, a memory 1406, a transceiver 1408, and an I/O controller 1410. These components may be in electronic communication or otherwise coupled (e.g., operatively, communicatively, functionally, electronically, electrically) via one or more interfaces (e.g., buses).

The processor 1404, the memory 1406, the transceiver 1408, or various combinations thereof or various components thereof may be examples of means for performing various aspects of the present disclosure as described herein. For example, the processor 1404, the memory 1406, the transceiver 1408, or various combinations or components thereof may support a method for performing one or more of the operations described herein.

In some implementations, the processor 1404, the memory 1406, the transceiver 1408, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 1404 and the memory 1406 coupled with the processor 1404 may be configured to perform one or more of the functions described herein (e.g., executing, by the processor 1404, instructions stored in the memory 1406).

For example, the processor 1404 may support wireless communication at the device 1402 in accordance with examples as disclosed herein. Processor 1404 may be configured as or otherwise support to: receive, from a UE, a first signaling indicating a carrier phase measurement report in accordance with a carrier phase positioning reporting configuration, where the carrier phase positioning reporting configuration includes at least a set of receiver error types and a carrier phase granularity, and where the carrier phase measurement report includes at least one carrier phase positioning measurement; obtain, based on the carrier phase measurement report, a location information of the UE.

For example, the processor 1404 may support wireless communication at the device 1402 in accordance with examples as disclosed herein. Processor 1404 may be configured as or otherwise support to: receive, from a UE, a first signaling indicating a carrier phase measurement report in accordance with a carrier phase positioning reporting configuration, where the carrier phase positioning reporting configuration includes at least a carrier phase granularity, and where the carrier phase measurement report includes at least one carrier phase positioning measurement; obtain, based on the carrier phase measurement report, a location information of the UE.

Additionally or alternatively, the processor 1404 may be configured to or otherwise support: where the apparatus comprises a network entity and the processor is further configured to cause the apparatus to: transmit, to the UE, the carrier phase reporting configuration; where the apparatus comprises a network entity and the processor is further configured to cause the apparatus to: transmit, to the UE, a carrier phase measurement request to report uplink carrier phase measurements, the carrier phase measurement request including the carrier phase reporting configuration; where the carrier phase reporting configuration further includes a request to provide additional RAT-dependent positioning measurements including at least one of a DL-RSTD, a UE Rx-Tx time difference, a DL PRS RSRP, a DL PRS RSRPP, a SL-RSTD, a SL-RTOA, a SL PRS RSRP, a SL PRS RSRPP, or a SL-AoA; where the carrier phase positioning reporting configuration includes a set of receiver error types including at least one of an initial phase offset, an initial phase offset group, a UE antenna reference point location error, an oscillator drift or clock offset, a carrier frequency offset, and an antenna phase center offset; where each of the error types is associated with an identifier; where the at least one carrier phase positioning measurement is reported in the carrier phase measurement report per TRP in a form of a plurality of single carrier phase measurements or per pair of TRPs in a form of a plurality of reference signal carrier phase difference measurements; where the at least one carrier phase positioning measurement is reported in the carrier phase measurement report based on a defined granularity or step values in terms of radians or degrees; where the at least one carrier phase positioning measurement is reported in the carrier phase measurement report based on a defined quality metric; where a delta or difference carrier phase measurement is reported in the carrier phase measurement report with respect to a previously performed carrier phase positioning measurement and a current carrier phase measurement; where the processor is further configured to cause the apparatus to receive, from the UE, a UE error cause related to carrier phase positioning; where the apparatus comprises a configuration entity, and where the processor is further configured to cause the apparatus to transmit, to the UE, a configuration entity error cause related to carrier phase positioning; where the processor is further configured to cause the apparatus to support, via capability request and response messages, awareness of devices capable of supporting carrier phase measurements; where the processor is further configured to cause the apparatus to receive a request for PRU carrier phase measurements and/or associated information, and transmit, to the UE, a response of PRU carrier phase measurements and/or associated information in a case of UE-based positioning; where the associated information includes at least one of PRU integer ambiguity information and quality metrics PRS resource IDs, PRS resource set IDs, TRP IDs, PRU identifying information, PRU IDs, LOS/NLOS information related to each of the carrier phase positioning measurements, additional path information related to each of the carrier phase positioning measurements, PRU receiver error type information including any oscillator drift, clock drift, initial PRU phase offsets or group of phase offsets, PRU ARP location error, PRU phase center offset, PRU measurement time stamp information, or carrier phase or timing measurement quality metrics.

For example, the processor 1404 may support wireless communication at the device 1402 in accordance with examples as disclosed herein. Processor 1404 may be configured as or otherwise support a means for receiving, from a UE, a first signaling indicating a carrier phase measurement report in accordance with a carrier phase positioning reporting configuration, where the carrier phase positioning reporting configuration includes at least a set of receiver error types and a carrier phase granularity, and where the carrier phase measurement report includes at least one carrier phase positioning measurement; and obtaining, based on the carrier phase measurement report, a location information of the UE.

For example, the processor 1404 may support wireless communication at the device 1402 in accordance with examples as disclosed herein. Processor 1404 may be configured as or otherwise support a means for receiving, from a UE, a first signaling indicating a carrier phase measurement report in accordance with a carrier phase positioning reporting configuration, where the carrier phase positioning reporting configuration includes at least a carrier phase granularity, and where the carrier phase measurement report includes at least one carrier phase positioning measurement; and obtaining, based on the carrier phase measurement report, a location information of the UE.

Additionally or alternatively, the processor 1404 may be configured to or otherwise support: where the method is implemented in a network entity, and the method further including: transmitting, to the UE, the carrier phase reporting configuration; where the method is implemented in a network entity, and the method further including: transmitting, to the UE, a carrier phase measurement request to report uplink carrier phase measurements, the carrier phase measurement request including the carrier phase reporting configuration; where the carrier phase reporting configuration further includes a request to provide additional RAT-dependent positioning measurements including at least one of a DL-RSTD, a UE Rx-Tx time difference, a DL PRS RSRP, a DL PRS RSRPP, a SL-RSTD, a SL-RTOA, a SL PRS RSRP, a SL PRS RSRPP, or a SL-AoA; where the carrier phase positioning reporting configuration includes a set of receiver error types including at least one of an initial phase offset, an initial phase offset group, a UE antenna reference point location error, an oscillator drift or clock offset, a carrier frequency offset, and an antenna phase center offset; where each of the error types is associated with an identifier; where the at least one carrier phase positioning measurement is reported in the carrier phase measurement report per TRP in a form of a plurality of single carrier phase measurements or per pair of TRPs in a form of a plurality of reference signal carrier phase difference measurements; where the at least one carrier phase positioning measurement is reported in the carrier phase measurement report based on a defined granularity or step values in terms of radians or degrees; where the at least one carrier phase positioning measurement is reported in the carrier phase measurement report based on a defined quality metric; where a delta or difference carrier phase measurement is reported in the carrier phase measurement report with respect to a previously performed carrier phase positioning measurement and a current carrier phase measurement; receiving, from the UE, a UE error cause related to carrier phase positioning; transmitting, to the UE, a configuration entity error cause related to carrier phase positioning; supporting, via capability request and response messages, awareness of devices capable of supporting carrier phase measurements; receiving a request for PRU carrier phase measurements and/or associated information, and transmitting, to the UE, a response of PRU carrier phase measurements and/or associated information in a case of UE-based positioning; where the associated information includes at least one of PRU integer ambiguity information and quality metrics PRS resource IDs, PRS resource set IDs, TRP IDs, PRU identifying information, PRU IDs, LOS/NLOS information related to each of the carrier phase positioning measurements, additional path information related to each of the carrier phase positioning measurements, PRU receiver error type information including any oscillator drift, clock drift, initial PRU phase offsets or group of phase offsets, PRU ARP location error, PRU phase center offset, PRU measurement time stamp information, or carrier phase or timing measurement quality metrics.

The processor 1404 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 1404 may be configured to operate a memory array using a memory controller. In some other implementations, a memory controller may be integrated into the processor 1404. The processor 1404 may be configured to execute computer-readable instructions stored in a memory (e.g., the memory 1406) to cause the device 1402 to perform various functions of the present disclosure.

The memory 1406 may include random access memory (RAM) and read-only memory (ROM). The memory 1406 may store computer-readable, computer-executable code including instructions that, when executed by the processor 1404 cause the device 1402 to perform various functions described herein. The code may be stored in a non-transitory computer-readable medium such as system memory or another type of memory. In some implementations, the code may not be directly executable by the processor 1404 but may cause a computer (e.g., when compiled and executed) to perform functions described herein. In some implementations, the memory 1406 may include, among other things, a basic I/O system (BIOS) which may control basic hardware or software operation such as the interaction with peripheral components or devices.

The I/O controller 1410 may manage input and output signals for the device 1402. The I/O controller 1410 may also manage peripherals not integrated into the device 1402. In some implementations, the I/O controller 1410 may represent a physical connection or port to an external peripheral. In some implementations, the I/O controller 1410 may utilize an operating system such as iOS®, ANDROID®, MS-DOS®, MS-WINDOWS®, OS/2®, UNIX®, LINUX®, or another known operating system. In some implementations, the I/O controller 1410 may be implemented as part of a processor, such as the processor 1404. In some implementations, a user may interact with the device 1402 via the I/O controller 1410 or via hardware components controlled by the I/O controller 1410.

In some implementations, the device 1402 may include a single antenna 1412. However, in some other implementations, the device 1402 may have more than one antenna 1412 (i.e., multiple antennas), including multiple antenna panels or antenna arrays, which may be capable of concurrently transmitting or receiving multiple wireless transmissions. The transceiver 1408 may communicate bi-directionally, via the one or more antennas 1412, wired, or wireless links as described herein. For example, the transceiver 1408 may represent a wireless transceiver and may communicate bi-directionally with another wireless transceiver. The transceiver 1408 may also include a modem to modulate the packets, to provide the modulated packets to one or more antennas 1412 for transmission, and to demodulate packets received from the one or more antennas 1412.

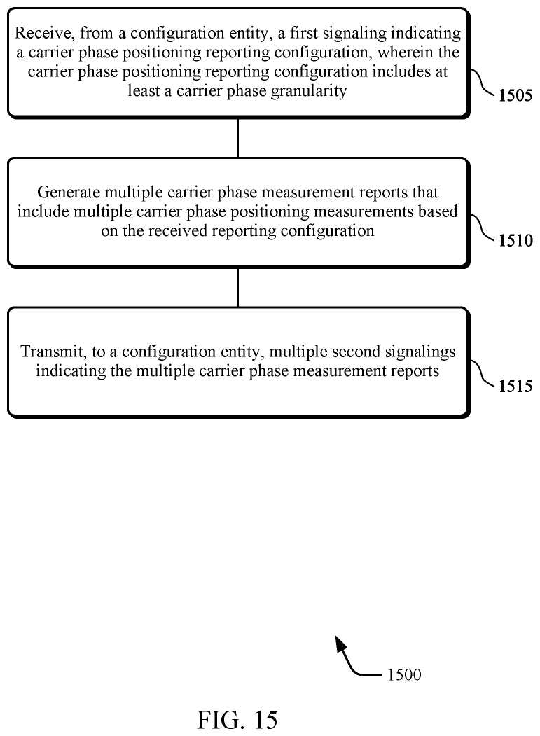

FIG. 15 illustrates a flowchart of a method 1500 that supports carrier phase positioning reporting in accordance with aspects of the present disclosure. The operations of the method 1500 may be implemented by a device or its components as described herein. For example, the operations of the method 1500 may be performed by a UE 104 as described with reference to FIGS. 1 through 14. In some implementations, the device may execute a set of instructions to control the function elements of the device to perform the described functions. Additionally, or alternatively, the device may perform aspects of the described functions using special-purpose hardware.

At 1505, the method may include receiving, from a configuration entity, a first signaling indicating a carrier phase positioning reporting configuration, wherein the carrier phase positioning reporting configuration includes at least a carrier phase granularity. The operations of 1505 may be performed in accordance with examples as described herein. In some implementations, aspects of the operations of 1505 may be performed by a device as described with reference to FIG. 1.

At 1510, the method may include generating multiple carrier phase measurement reports that include multiple carrier phase positioning measurements based on the received reporting configuration. The operations of 1510 may be performed in accordance with examples as described herein. In some implementations, aspects of the operations of 1510 may be performed by a device as described with reference to FIG. 1.

At 1515, the method may include transmitting, to a configuration entity, multiple second signalings indicating the multiple carrier phase measurement reports. The operations of 1515 may be performed in accordance with examples as described herein. In some implementations, aspects of the operations of 1515 may be performed by a device as described with reference to FIG. 1.

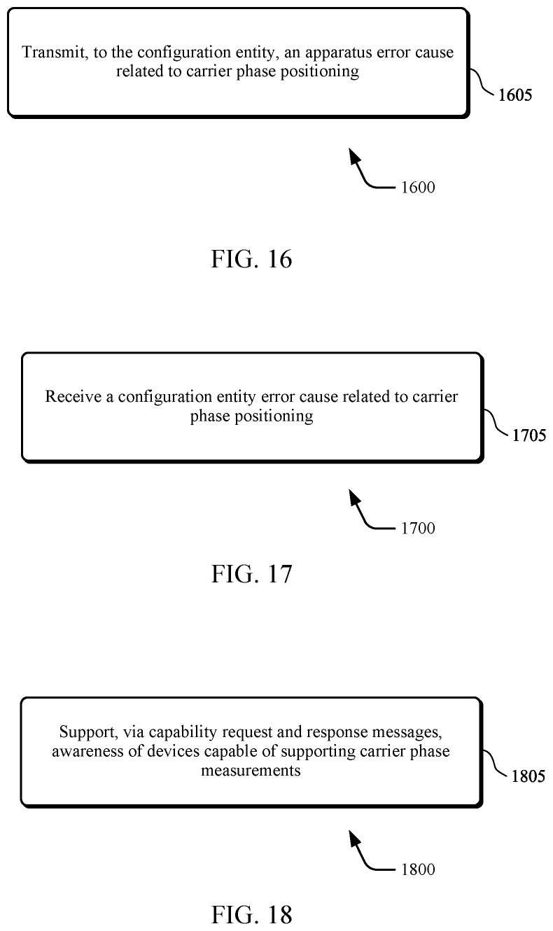

FIG. 16 illustrates a flowchart of a method 1600 that supports carrier phase positioning reporting in accordance with aspects of the present disclosure. The operations of the method 1600 may be implemented by a device or its components as described herein. For example, the operations of the method 1600 may be performed by a UE 104 as described with reference to FIGS. 1 through 14. In some implementations, the device may execute a set of instructions to control the function elements of the device to perform the described functions. Additionally, or alternatively, the device may perform aspects of the described functions using special-purpose hardware.

At 1605, the method may include transmitting, to the configuration entity, an apparatus error cause related to carrier phase positioning. The operations of 1605 may be performed in accordance with examples as described herein. In some implementations, aspects of the operations of 1605 may be performed by a device as described with reference to FIG. 1.

FIG. 17 illustrates a flowchart of a method 1700 that supports carrier phase positioning reporting in accordance with aspects of the present disclosure. The operations of the method 1700 may be implemented by a device or its components as described herein. For example, the operations of the method 1700 may be performed by a UE 104 as described with reference to FIGS. 1 through 14. In some implementations, the device may execute a set of instructions to control the function elements of the device to perform the described functions. Additionally, or alternatively, the device may perform aspects of the described functions using special-purpose hardware.

At 1705, the method may include receiving a configuration entity error cause related to carrier phase positioning. The operations of 1705 may be performed in accordance with examples as described herein. In some implementations, aspects of the operations of 1705 may be performed by a device as described with reference to FIG. 1.

FIG. 18 illustrates a flowchart of a method 1800 that supports carrier phase positioning reporting in accordance with aspects of the present disclosure. The operations of the method 1800 may be implemented by a device or its components as described herein. For example, the operations of the method 1800 may be performed by a UE 104 as described with reference to FIGS. 1 through 14. In some implementations, the device may execute a set of instructions to control the function elements of the device to perform the described functions. Additionally, or alternatively, the device may perform aspects of the described functions using special-purpose hardware.

At 1805, the method may include supporting, via capability request and response messages, awareness of devices capable of supporting carrier phase measurements. The operations of 1805 may be performed in accordance with examples as described herein. In some implementations, aspects of the operations of 1805 may be performed by a device as described with reference to FIG. 1.

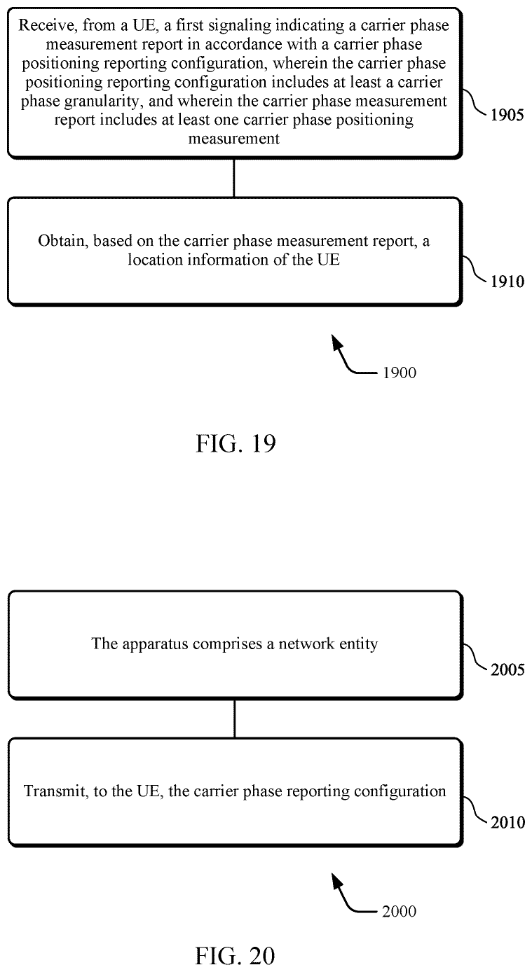

FIG. 19 illustrates a flowchart of a method 1900 that supports carrier phase positioning reporting in accordance with aspects of the present disclosure. The operations of the method 1900 may be implemented by a device or its components as described herein. For example, the operations of the method 1900 may be performed by a network entity 102 as described with reference to FIGS. 1 through 14. In some implementations, the device may execute a set of instructions to control the function elements of the device to perform the described functions. Additionally, or alternatively, the device may perform aspects of the described functions using special-purpose hardware.

At 1905, the method may include receiving, from a UE, a first signaling indicating a carrier phase measurement report in accordance with a carrier phase positioning reporting configuration, wherein the carrier phase positioning reporting configuration includes at least a carrier phase granularity, and wherein the carrier phase measurement report includes at least one carrier phase positioning measurement. The operations of 1905 may be performed in accordance with examples as described herein. In some implementations, aspects of the operations of 1905 may be performed by a device as described with reference to FIG. 1.

At 1910, the method may include obtaining, based on the carrier phase measurement report, a location information of the UE. The operations of 1910 may be performed in accordance with examples as described herein. In some implementations, aspects of the operations of 1910 may be performed by a device as described with reference to FIG. 1.

FIG. 20 illustrates a flowchart of a method 2000 that supports carrier phase positioning reporting in accordance with aspects of the present disclosure. The operations of the method 2000 may be implemented by a device or its components as described herein. For example, the operations of the method 2000 may be performed by a network entity 102 as described with reference to FIGS. 1 through 14. In some implementations, the device may execute a set of instructions to control the function elements of the device to perform the described functions. Additionally, or alternatively, the device may perform aspects of the described functions using special-purpose hardware.

At 2005, the method may include the apparatus comprises a network entity. The operations of 2005 may be performed in accordance with examples as described herein. In some implementations, aspects of the operations of 2005 may be performed by a device as described with reference to FIG. 1.

At 2010, the method may include transmitting, to the UE, the carrier phase reporting configuration. The operations of 2010 may be performed in accordance with examples as described herein. In some implementations, aspects of the operations of 2010 may be performed by a device as described with reference to FIG. 1.

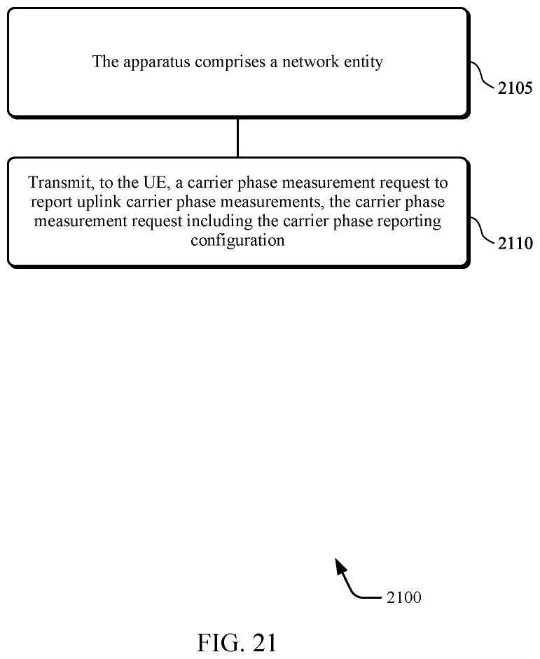

FIG. 21 illustrates a flowchart of a method 2100 that supports carrier phase positioning reporting in accordance with aspects of the present disclosure. The operations of the method 2100 may be implemented by a device or its components as described herein. For example, the operations of the method 2100 may be performed by a network entity 102 as described with reference to FIGS. 1 through 14. In some implementations, the device may execute a set of instructions to control the function elements of the device to perform the described functions. Additionally, or alternatively, the device may perform aspects of the described functions using special-purpose hardware.

At 2105, the method may include the apparatus comprises a network entity. The operations of 2105 may be performed in accordance with examples as described herein. In some implementations, aspects of the operations of 2105 may be performed by a device as described with reference to FIG. 1.

At 2110, the method may include transmitting, to the UE, a carrier phase measurement request to report uplink carrier phase measurements, the carrier phase measurement request including the carrier phase reporting configuration. The operations of 2110 may be performed in accordance with examples as described herein. In some implementations, aspects of the operations of 2110 may be performed by a device as described with reference to FIG. 1.

It should be noted that the methods described herein describes possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Similarly, a list of at least one of A; B; or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment (UE) for wireless communication, comprising:
at least one memory; and
at least one processor coupled with the at least one memory and operable to cause the UE to:
receive a carrier phase positioning reporting configuration that includes a carrier phase granularity;
generate multiple carrier phase measurement reports that include multiple carrier phase positioning measurements based at least in part on the received reporting configuration;
transmit the multiple carrier phase measurement reports.

2. The UE of claim 1, wherein the carrier phase reporting configuration further includes a request to provide additional radio access technology (RAT)-dependent positioning measurements including at least one of a downlink reference signal time difference (DL-RSTD), a user equipment receive-transmit (UE Rx-Tx) time difference, a downlink positioning reference signals reference signal received power (DL PRS RSRP), a downlink positioning reference signals reference signal received path power (DL PRS RSRPP), a sidelink reference signal time difference (SL-RSTD), a sidelink relative time of arrival (SL-RTOA), a sidelink positioning reference signals reference signal received power (SL PRS RSRP), a sidelink positioning reference signals reference signal received path power (SL PRS RSRPP), or a sidelink angle-of-arrival (SL-AoA).

3. The UE of claim 1, wherein the carrier phase positioning reporting configuration includes a set of receiver error types including at least one of an initial phase offset, an initial phase offset group, a UE antenna reference point location error, an oscillator drift or clock offset, a carrier frequency offset, or an antenna phase center offset.

4. The UE of claim 3, wherein each of the error types is associated with an identifier.

5. The UE of claim 1, wherein the carrier phase positioning measurements are reported in the carrier phase measurement reports per transmission-reception point (TRP) in a form of a plurality of single carrier phase measurements or per pair of TRPs in a form of a plurality of reference signal carrier phase difference measurements.

6. The UE of claim 1, wherein the carrier phase positioning measurements are reported in the carrier phase measurement reports based on a defined granularity or step values in terms of radians or degrees.

7. The UE of claim 1, wherein the carrier phase positioning measurements are reported in the carrier phase measurement reports based on a defined quality metric.

8. The UE of claim 1, wherein a delta or difference carrier phase measurement is reported in the carrier phase measurement reports with respect to a previously performed carrier phase positioning measurement and a current carrier phase measurement.

9. The UE of claim 1, wherein the at least one processor is further operable to cause the UE to transmit an apparatus error cause related to carrier phase positioning.

10. The UE of claim 1, wherein the at least one processor is further operable to cause the UE to receive a configuration entity error cause related to carrier phase positioning.

11. The UE of claim 1, wherein the at least one processor is further operable to cause the UE to support, via capability request and response messages, awareness of devices capable of supporting carrier phase measurements.

12. The UE of claim 1, wherein the at least one processor is further operable to cause the UE to transmit a request for positioning reference unit (PRU) carrier phase measurements and/or associated information, and receive a response of PRU carrier phase measurements and/or associated information in a case of UE-based positioning.

13. The UE of claim 12, wherein the associated information includes at least one of PRU integer ambiguity information and quality metrics positioning reference signals (PRS) resource identifiers (IDs), PRS resource set IDs, transmission-reception point (TRP) IDs, PRU identifying information, PRU IDs, line-of-sight (LOS)/non-line-of-sight (NLOS) information related to each of the carrier phase positioning measurements, additional path information related to each of the carrier phase positioning measurements, PRU receiver error type information including any oscillator drift, clock drift, initial PRU phase offsets or group of phase offsets, PRU antenna reference point (ARP) location error, PRU phase center offset, PRU measurement time stamp information, or carrier phase or timing measurement quality metrics.

14. A base station for wireless communication, comprising:
at least one memory; and
at least one processor coupled with the at least one memory and operable to cause the base station to:
receive a carrier phase measurement report in accordance with a carrier phase positioning reporting configuration, wherein the carrier phase positioning reporting configuration includes at least a carrier phase granularity, and wherein the carrier phase measurement report includes at least one carrier phase positioning measurement;
obtain, based on the carrier phase measurement report, a location information of a user equipment (UE).

15. A method performed by a user equipment (UE), the method comprising:
receiving a carrier phase positioning reporting configuration that includes at least a carrier phase granularity;
generating multiple carrier phase measurement reports that include multiple carrier phase positioning measurements based on the received reporting configuration; and
transmitting the multiple carrier phase measurement reports.

16-20. (canceled)

21. The base station of claim 14, wherein the at least one processor is further configured to cause the base station to:
transmit the carrier phase reporting configuration.

22. The base station of claim 14, wherein the at least one processor is further configured to cause the base station to:
transmit a carrier phase measurement request to report uplink carrier phase measurements, wherein the carrier phase measurement request includes the carrier phase reporting configuration.

23. The base station of claim 14, wherein the carrier phase reporting configuration further includes a request to provide additional radio access technology (RAT)-dependent positioning measurements including at least one of a downlink reference signal time difference (DL-RSTD), a user equipment receive-transmit (UE Rx-Tx) time difference, a downlink positioning reference signals reference signal received power (DL PRS RSRP), a downlink positioning reference signals reference signal received path power (DL PRS RSRPP), a sidelink reference signal time difference (SL-RSTD), a sidelink relative time of arrival (SL-RTOA), a sidelink positioning reference signals reference signal received power (SL PRS RSRP), a sidelink positioning reference signals reference signal received path power (SL PRS RSRPP), and a sidelink angle-of-arrival (SL-AoA).

24. The base station of claim 14, wherein the carrier phase positioning reporting configuration includes a set of receiver error types including at least one of an initial phase offset, an initial phase offset group, a UE antenna reference point location error, an oscillator drift or clock offset, a carrier frequency offset, or an antenna phase center offset.

25. A method performed by a base station, comprising:
receiving a carrier phase measurement report in accordance with a carrier phase positioning reporting configuration, wherein the carrier phase positioning reporting configuration includes at least a set of receiver error types and a carrier phase granularity, and wherein the carrier phase measurement report includes at least one carrier phase positioning measurement; and
obtaining, based on the carrier phase measurement report, a location information of a user equipment (UE).
